(19) United States
(12) Patent Application Publication
(10) Pub. No.: US 2024/0104413 A1
(43) Pub. Date: Mar. 28, 2024

(54) TECHNOLOGIES FOR HYBRID DIGITAL/ANALOG PROCESSORS FOR A QUANTUM COMPUTER

(71) Applicant: Intel Corporation, Santa Clara, CA (US)

(72) Inventors: Todor Mladenov, Portland, OR (US); Sahar Daraeizadeh, Lake Oswego, OR (US); Anne Matsuura, Portland, OR (US)

(73) Assignee: Intel Corporation, Santa Clara, CA (US)

(21) Appl. No.: 17/954,131

(22) Filed: Sep. 27, 2022

(51) Int. Cl. G06N 10/20

(52) U.S. Cl. CPC G06N 10/20

(57) ABSTRACT

Technologies for a hybrid digital/analog processor for a quantum computer are disclosed. In the illustrative embodiment, a hybrid digital/analog processor may be able to process digital instructions as well as analog instructions. The digital instructions may be, e.g., read from or write to memory or registers, perform an arithmetic operation, perform a branch, etc. The analog instructions may be to, e.g., provide an analog voltage to a particular electrode of a qubit, provide an analog pulse to a qubit, measure a reflection of an analog signal from a qubit, etc. The integration of analog operations in the hybrid digital/analog processor can improve performance by, e.g., lowering latency and lowering power usage.

### BACKGROUND

Quantum computers promise computational abilities not feasible with classical computing. One of many challenges in quantum computing is high-speed, low-latency communication with a large number of qubits. Approaches such as a finite state machine can manage a relatively small number of qubits but are unworkable for large numbers of qubits. The circuitry to manage the qubits should be close to the qubits in order to reduce latency. However, circuitry close to qubits in, e.g., a dilution refrigerator.

### BRIEF DESCRIPTION OF THE DRAWINGS

FIGS. 1A-1F illustrate various views of an example quantum dot device, in accordance with one embodiment.

FIG. 2 is a simplified block diagram of at least one embodiment of a quantum compute device.

FIG. 3 is a simplified block diagram of at least one embodiment of a portion of the quantum compute device of FIG. 2.

FIG. 4 is a simplified block diagram of at least one embodiment of a hybrid digital/analog processor of the quantum compute device of FIG. 1.

FIG. 5 is a simplified block diagram of at least one embodiment of a multi-core hybrid digital/analog processor of the quantum compute device of FIG. 1.

FIG. 6 is a simplified block diagram of at least one embodiment of a portion of the quantum compute device of FIG. 2 with multiple hybrid digital/analog processors.

FIG. 7 is a simplified block diagram of at least one embodiment of an environment that may be established by the quantum compute device of FIG. 2.

FIG. 8 is a simplified flow diagram of at least one embodiment of a method for executing a program on the hybrid digital/analog processor of FIG. 4.

FIG. 9 is a simplified flow diagram of at least one embodiment of a method for executing a program by the quantum compute device of FIG. 2.

FIG. 10 is a top view of a wafer and dies, in accordance with any of the embodiments disclosed herein.

FIG. 11 is a cross-sectional side view of an integrated circuit, in accordance with any of the embodiments disclosed herein.

FIGS. 12A-12D are perspective views of example planar, gate-all-around, and stacked gate-all-around transistors.

FIG. 13 is a cross-sectional side view of an integrated circuit device assembly, in accordance with any of the embodiments disclosed herein.

FIG. 14 is a block diagram of an example electrical device, in accordance with any of the embodiments disclosed herein.

### DETAILED DESCRIPTION

Aspects of the present disclosure include a quantum compute device with a hybrid digital/analog processor. In the illustrative embodiment, the hybrid digital/analog processor is located within a dilution refrigerator close to the qubits of the quantum compute device. In use, a processor in the quantum compute device sends instructions to the hybrid digital/analog processor. The processor may send digital instructions as well as analog instructions. Digital instructions may include e.g., reading and writing memory, arithmetic operations, conditional branches, reading and writing registers, etc. Analog instructions may include instructions to generate or read analog pulses send to and received from the qubits. The hybrid digital/analog processor may be able to coordinate operations on the qubits with lower latency, lower power, and better synchronization than use of a digital processor with separate analog signal processing circuitry.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact, and “coupled” may indicate elements co-operate or interact, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, a substrate assembly feature, such as a through width, that is described as having substantially a listed dimension can vary within a few percent of the listed dimension.

As used herein, the phrase “communicatively coupled” refers to the ability of a component to send a signal to or receive a signal from another component. The signal can be any type of signal, such as an input signal, an output signal, or a power signal. A component can send or receive a signal to another component to which it is communicatively coupled via a wired or wireless communication medium (e.g., conductive traces, conductive contacts, air). Examples of components that are communicatively coupled include integrated circuit dies located in the same package that communicate via an embedded bridge in a package substrate and an integrated circuit component attached to a printed circuit board that send signals to or receives signals from other integrated circuit components or electronic devices attached to the printed circuit board.

It will be understood that in the examples shown and described further below, the figures may not be drawn to scale and may not include all possible layers and/or circuit components. In addition, it will be understood that although certain figures illustrate transistor designs with source/drain regions, electrodes, etc. having orthogonal (e.g., perpendicular) boundaries, embodiments herein may implement such boundaries in a substantially orthogonal manner (e.g., within +/−5 or 10 degrees of orthogonality) due to fabrication methods used to create such devices or for other reasons.

As used herein, the phrase “located on” in the context of a first layer or component located on a second layer or component refers to the first layer or component being directly physically attached to the second part or component (no layers or components between the first and second layers or components) or physically attached to the second layer or component with one or more intervening layers or components.

As used herein, the term “adjacent” refers to layers or components that are in physical contact with each other. That is, there is no layer or component between the stated adjacent layers or components. For example, a layer X that is adjacent to a layer Y refers to a layer that is in physical contact with layer Y.

As used herein, the terms “upper”/“lower” or “above”/“below” may refer to relative locations of an object (e.g., the surfaces described above), especially in light of examples shown in the attached figures, rather than an absolute location of an object. For example, an upper surface of an apparatus may be on an opposite side of the apparatus from a lower surface of the object, and the upper surface may be facing upward generally only when viewed in a particular way. As another example, a first object above a second object may be on or near an “upper” surface of the second object rather than near a “lower” surface of the object, and the first object may be truly above the second object only when the two objects are viewed in a particular way.

References are made to the drawings, which are not necessarily drawn to scale, wherein similar or same numbers may be used to designate the same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

A quantum computer uses quantum-mechanical phenomena such as superposition and entanglement to perform computations, simulations, or other functions. In contrast to digital computers, which store data in one of two definite states (0 or 1), quantum computation uses quantum bits (qubits), which can be in superpositions of states. Qubits may be implemented using physically distinguishable quantum states of elementary particles such as electrons and photons. For example, the polarization of a photon may be used where the two states are vertical polarization and horizontal polarization. Similarly, the spin of an electron may have distinguishable states such as “up spin” and “down spin.” Qubits in quantum mechanical systems can be in a superposition of both states at the same time, a trait that is unique and fundamental to quantum computing.

Quantum computing systems execute algorithms containing quantum logic operations performed on qubits. In some cases, the result of the algorithm is not deterministic. The quantum algorithm may be repeated many times in order to determine a statistical distribution of results or in order to have a high likelihood of finding the correct answer. In some cases, a classical algorithm may be used to check if the quantum computer determined the correct result.

Qubits have been implemented using a variety of different technologies which are capable of manipulating and reading quantum states. These include but are not limited to quantum dot devices (spin based and spatial based), trapped-ion devices, superconducting quantum computers, optical lattices, nuclear magnetic resonance computers, solid-state NMR Kane quantum devices, electrons-on-helium quantum computers, cavity quantum electrodynamics (CQED) devices, molecular magnet computers, and fullerene-based ESR quantum computers, to name a few. Thus, while a quantum dot device is described below in relation to certain embodiments of the invention, the underlying principles of the invention may be employed in combination with any type of quantum computer, including, but not limited to, those listed above. The particular physical implementation used for qubits is not necessarily required for the embodiments of the invention described herein.

Quantum dots are small semiconductor particles, typically a few nanometers in size. Because of this small size, quantum dots operate according to the rules of quantum mechanics, having optical and electronic properties which differ from macroscopic entities. Quantum dots are sometimes referred to as “artificial atoms” to connote the fact that a quantum dot is a single object with discrete, bound electronic states, as is the case with atoms or molecules.

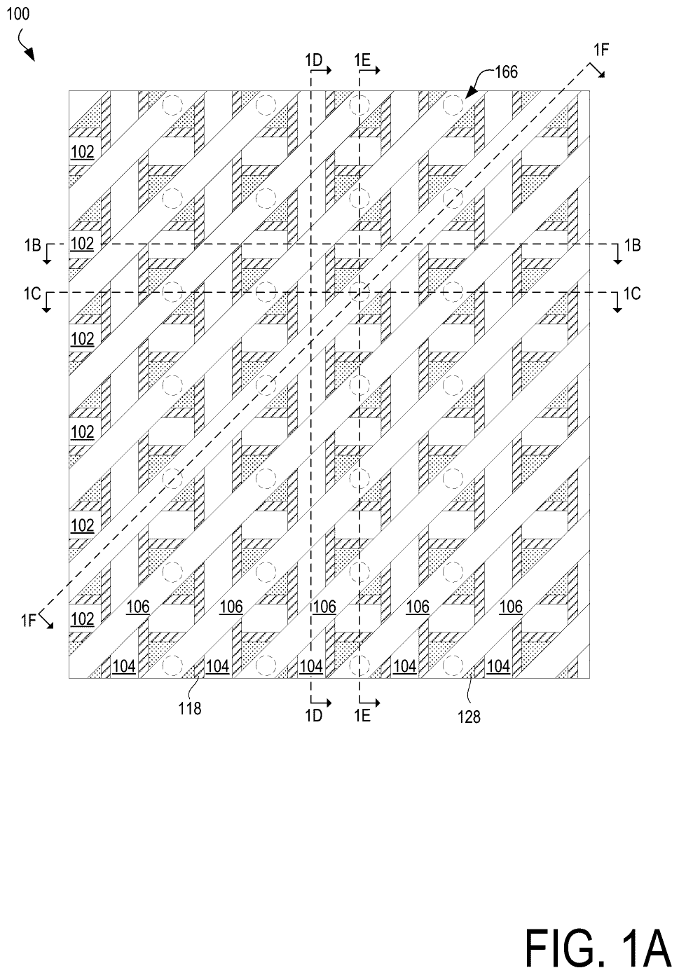

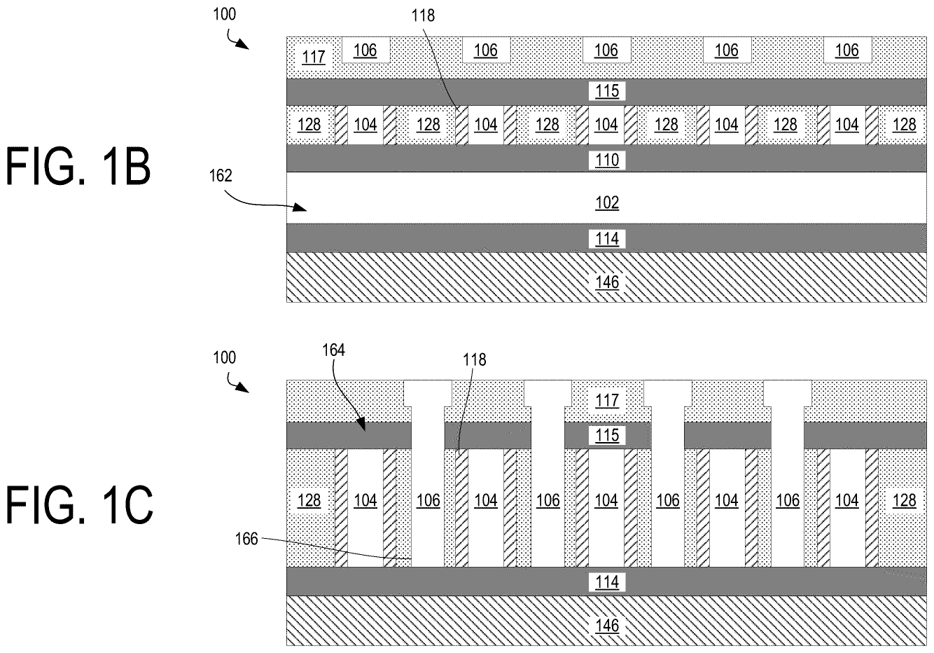

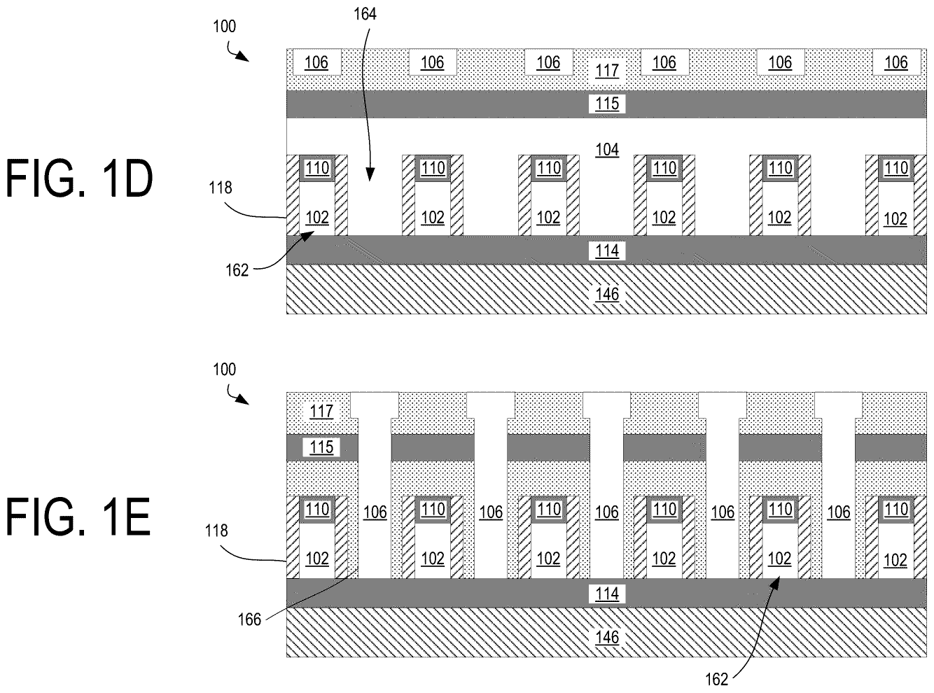

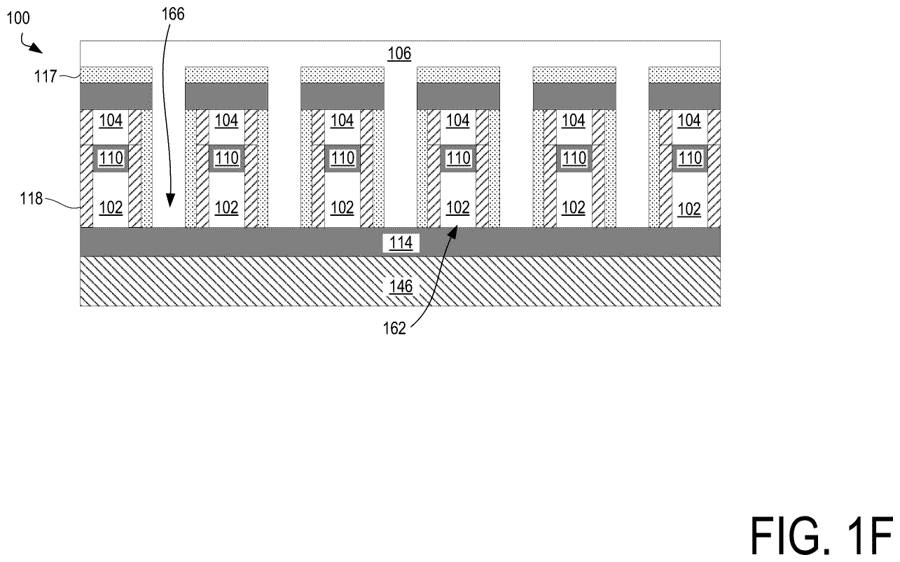

FIGS. 1A-1F are various views of a quantum dot device 100, which may be used with embodiments of the invention described below. FIG. 1A is a top view of a portion of the quantum dot device 100 with some of the materials removed so that the first gate lines 102, the second gate lines 104, and the third gate lines 106 are visible. Although many of the drawings and description herein may refer to a particular set of lines or gates as “barrier” or “quantum dot” lines or gates, respectively, this is simply for ease of discussion, and in other embodiments, the role of “barrier” and “quantum dot” lines and gates may be switched (e.g., barrier gates may instead act as quantum dot gates, and vice versa). FIGS. 1B-1F are side cross-sectional views of the quantum dot device 100 of FIG. 1A; in particular, FIG. 1B is a view through the section B-B of FIG. 1A, FIG. 1C is a view through the section C-C of FIG. 1A, FIG. 1D is a view through the section D-D of FIG. 1A, FIG. 1E is a view through the section E-E of FIG. 1A, and FIG. 1F is a view through the section F-F of FIG. 1A.

The quantum dot device 100 of FIG. 1 may be operated in any of a number of ways. For example, in some embodiments, electrical signals such as voltages, currents, radio frequency (RF), and/or microwave signals, may be provided to one or more first gate line 102, second gate line 104, and/or third gate line 106 to cause a quantum dot (e.g., an electron spin-based quantum dot or a hole spin-based quantum dot) to form in a quantum well stack 146 under a third gate 166 of a third gate line 106. Electrical signals provided to a third gate line 106 may control the electrical potential of a quantum well under the third gates 166 of that third gate line 106, while electrical signals provided to a first gate line 102 (and/or a second gate line 104) may control the potential energy barrier under the first gates 162 of that first gate line 102 (and/or the second gates 164 of that second gate line 104) between adjacent quantum wells. Quantum interactions between quantum dots in different quantum wells in the quantum well stack 146 (e.g., under different quantum dot gates) may be controlled in part by the potential energy barrier provided by the barrier potentials imposed between them (e.g., by intervening barrier gates).

Generally, the quantum dot devices 100 disclosed herein may further include a source of magnetic fields (not shown) that may be used to create an energy difference in the states of a quantum dot (e.g., the spin states of an electron spin-based quantum dot) that are normally degenerate, and the states of the quantum dots (e.g., the spin states) may be manipulated by applying electromagnetic energy to the gates lines to create quantum bits capable of computation. The source of magnetic fields may be one or more magnet lines. Thus, the quantum dot devices 100 disclosed herein may, through controlled application of electromagnetic energy, be able to manipulate the position, number, and quantum state (e.g., spin) of quantum dots in the quantum well stack 146.

In the quantum dot device 100 of FIG. 1, a gate dielectric 114 may be disposed on a quantum well stack 146. A quantum well stack 146 may include at least one quantum well layer (not shown in FIG. 1) in which quantum dots may be localized during operation of the quantum dot device 100. The gate dielectric 114 may be any suitable material, such as a high-k material. Multiple parallel first gate lines 102 may be disposed on the gate dielectric 114, and spacer material 118 may be disposed on side faces of the first gate lines 102. In some embodiments, a patterned hardmask 110 may be disposed on the first gate lines 102 (with the pattern corresponding to the pattern of the first gate lines 102), and the spacer material 118 may extend up the sides of the hardmask 110, as shown. The first gate lines 102 may each be a first gate 162. Different ones of the first gate lines 102 may be electrically controlled in any desired combination (e.g., each first gate line 102 may be separately electrically controlled, or some or all the first gate lines 102 may be shorted together in one or more groups, as desired).

Multiple parallel second gate lines 104 may be disposed over and between the first gate lines 102. As illustrated in FIG. 1, the second gate lines 104 may be arranged perpendicular to the first gate lines 102. The second gate lines 104 may extend over the hardmask 110, and may include second gates 164 that extend down toward the quantum well stack 146 and contact the gate dielectric 114 between adjacent ones of the first gate lines 102, as illustrated in FIG. 1D. In some embodiments, the second gates 164 may fill the area between adjacent ones of the first gate lines 102/spacer material 118 structures; in other embodiments, an insulating material (not shown) may be present between the first gate lines 102/spacer material 118 structures and the proximate second gates 164. In some embodiments, spacer material 118 may be disposed on side faces of the second gate lines 104; in other embodiments, no spacer material 118 may be disposed on side faces of the second gate lines 104. In some embodiments, a hardmask 115 may be disposed above the second gate lines 104. Multiple ones of the second gates 164 of a second gate line 104 are electrically continuous (due to the shared conductive material of the second gate line 104 over the hardmask 110). Different ones of the second gate lines 104 may be electrically controlled in any desired combination (e.g., each second gate line 104 may be separately electrically controlled, or some or all the second gate lines 104 may be shorted together in one or more groups, as desired). Together, the first gate lines 102 and the second gate lines 104 may form a grid, as depicted in FIG. 1.

Multiple parallel third gate lines 106 may be disposed over and between the first gate lines 102 and the second gate lines 104. As illustrated in FIG. 1, the third gate lines 106 may be arranged diagonal to the first gate lines 102, and diagonal to the second gate lines 104. In particular, the third gate lines 106 may be arranged diagonally over the openings in the grid formed by the first gate lines 102 and the second gate lines 104. The third gate lines 106 may include third gates 166 that extend down to the gate dielectric 114 in the openings in the grid formed by the first gate lines 102 and the second gate lines 104; thus, each third gate 166 may be bordered by two different first gate lines 102 and two different second gate lines 104. In some embodiments, the third gates 166 may be bordered by insulating material 128; in other embodiments, the third gates 166 may fill the openings in the grid (e.g., contacting the spacer material 118 disposed on side faces of the adjacent first gate lines 102 and the second gate lines 104, not shown). Additional insulating material 117 may be disposed on and/or around the third gate lines 106. Multiple ones of the third gates 166 of a third gate line 106 are electrically continuous (due to the shared conductive material of the third gate line 106 over the first gate lines 102 and the second gate lines 104). Different ones of the third gate lines 106 may be electrically controlled in any desired combination (e.g., each third gate line 106 may be separately electrically controlled, or some or all the third gate lines 106 may be shorted together in one or more groups, as desired).

Although Figures IA-F illustrate a particular number of first gate lines 102, second gate lines 104, and third gate lines 106, this is simply for illustrative purposes, and any number of first gate lines 102, second gate lines 104, and third gate lines 106 may be included in a quantum dot device 100. Other examples of arrangements of first gate lines 102, second gate lines 104, and third gate lines 106 are possible. Electrical interconnects (e.g., vias and conductive lines) may contact the first gate lines 102, second gate lines 104, and third gate lines 106 in any desired manner.

Not illustrated in FIG. 1 are accumulation regions that may be electrically coupled to the quantum well layer of the quantum well stack 146 (e.g., laterally proximate to the quantum well layer). The accumulation regions may be spaced apart from the gate lines by a thin layer of an intervening dielectric material. The accumulation regions may be regions in which carriers accumulate (e.g., due to doping, or due to the presence of large electrodes that pull carriers into the quantum well layer), and may serve as reservoirs of carriers that can be selectively drawn into the areas of the quantum well layer under the third gates 166 (e.g., by controlling the voltages on the quantum dot gates, the first gates 162, and the second gates 164) to form carrier-based quantum dots (e.g., electron or hole quantum dots, including a single charge carrier, multiple charge carriers, or no charge carriers). In other embodiments, a quantum dot device 100 may not include lateral accumulation regions, but may instead include doped layers within the quantum well stack 146. These doped layers may provide the carriers to the quantum well layer. Any combination of accumulation regions (e.g., doped or non-doped) or doped layers in a quantum well stack 146 may be used in any of the embodiments of the quantum dot devices 100 disclosed herein.

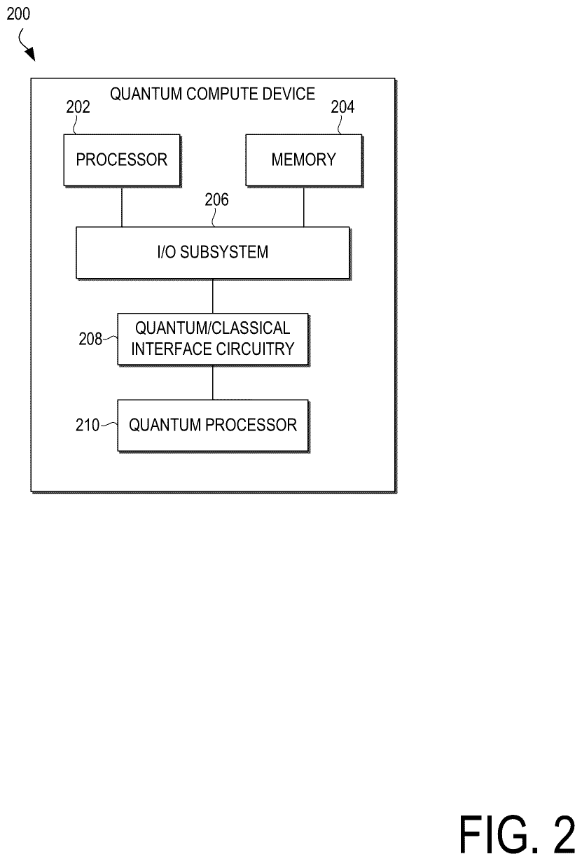

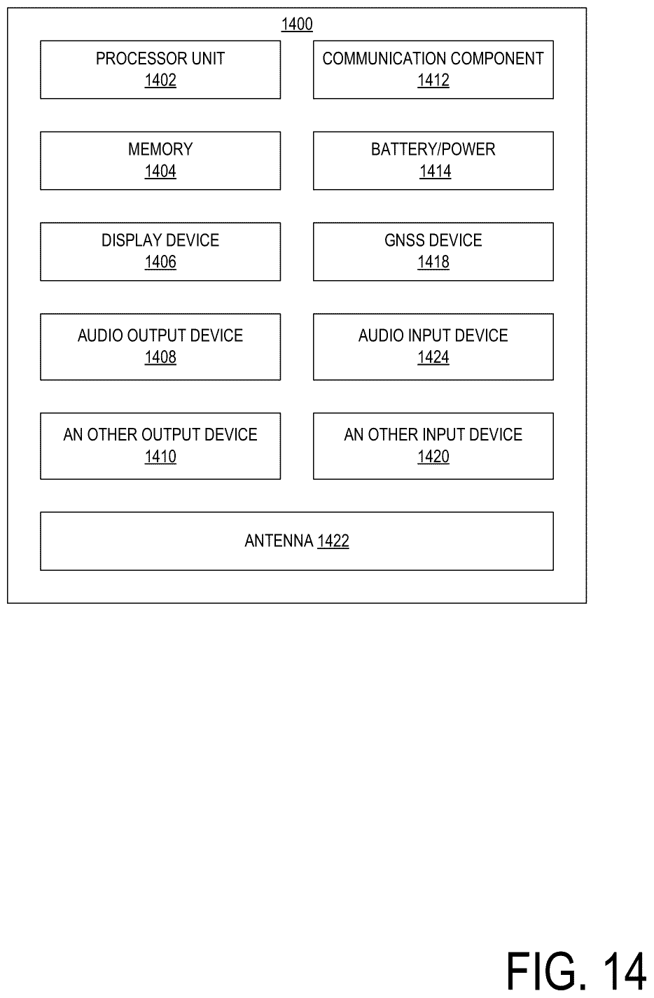

Referring now to FIG. 2, a simplified block diagram of a quantum compute device 200 is shown. In some embodiments, the quantum compute device 200 may include the quantum dot devices 100 described above in regard to FIGS. 1A-1F. The quantum compute device 200 may be embodied as or included in any type of compute device. For example, the quantum compute device 200 may include or otherwise be included in, without limitation, a server computer, an embedded computing system, a System-on-a-Chip (SoC), a multiprocessor system, a processor-based system, a consumer electronic device, a desktop computer, a laptop computer, a network device, a networked computer, a distributed computing system, and/or any other computing device. The illustrative quantum compute device 200 includes a processor 202, a memory 204, an input/output (I/O) subsystem 206, a quantum/classical interface circuitry 208, and a quantum processor 210. In some embodiments, one or more of the illustrative components of the quantum compute device 200 may be incorporated in, or otherwise form a portion of, another component. For example, the memory 204, or portions thereof, may be incorporated in the processor 202 in some embodiments. In some embodiments, the quantum compute device 200 may be embodied as the electrical device 1400 described below in regard to FIG. 14 or may include any suitable component of the electrical device 1400.

In some embodiments, the quantum compute device 200 may be located in a data center with other compute devices, such as an enterprise data center (e.g., a data center owned and operated by a company and typically located on company premises), managed services data center (e.g., a data center managed by a third party on behalf of a company), a colocated data center (e.g., a data center in which data center infrastructure is provided by the data center host and a company provides and manages their own data center components (servers, etc.)), cloud data center (e.g., a data center operated by a cloud services provider that host companies applications and data), and an edge data center (e.g., a data center, typically having a smaller footprint than other data center types, located close to the geographic area that it serves), a micro data center, etc. In some embodiments, the quantum compute device 200 may receive jobs over a network (such as the Internet) to perform on the quantum processor 210. The quantum compute device 200 may perform the jobs on the quantum processor 210 and send the results back to the requesting device.

The processor 202 may be embodied as any type of processor capable of performing the functions described herein. For example, the processor 202 may be embodied as a single or multi-core processor(s), a single or multi-socket processor, a digital signal processor, a graphics processor, a neural network compute engine, an image processor, a microcontroller, or other processor or processing/controlling circuit. The processor 202 may include multiple processor cores. In some embodiments, the processor 202 supports quantum extensions to an existing ISA of the processor/core 202, allowing instructions that interface with the quantum/classical interface circuitry 208 and the quantum processor 210.

The memory 204 may be embodied as any type of volatile or non-volatile memory or data storage capable of performing the functions described herein. In operation, the memory 204 may store various data and software used during operation of the quantum compute device 200, such as operating systems, applications, programs, libraries, and drivers. The memory 204 is communicatively coupled to the processor 202 via the I/O subsystem 206, which may be embodied as circuitry and/or components to facilitate input/output operations with the processor 202, the memory 204, and other components of the quantum compute device 200. For example, the I/O subsystem 206 may be embodied as, or otherwise include, memory controller hubs, input/output control hubs, firmware devices, communication links (e.g., point-to-point links, bus links, wires, cables, light guides, printed circuit board traces, etc.) and/or other components and subsystems to facilitate the input/output operations. The I/O subsystem 206 may connect various internal and external components of the quantum compute device 200 to each other with use of any suitable connector, interconnect, bus, protocol, etc., such as an SoC fabric, PCIe®, USB2, USB3, USB4, NVMe®, Thunderbolt®, Compute Express Link (CXL), and/or the like. In some embodiments, the I/O subsystem 206 may form a portion of a system-on-a-chip (SoC) and be incorporated, along with the processor 202 and the memory 204 and other components of the quantum compute device 200 on a single integrated circuit chip.

The quantum/classical interface circuitry 208 is configured to interface with both classical components of the quantum compute device 200, such as the processor 202 and memory 204, as well as the quantum processor 210. The quantum/classical interface circuitry 208 may include a variety of analog or digital circuitry, such as analog-to-digital converters, digital-to-analog converters, high gain amplifiers, low noise amplifiers, cryogenic amplifiers, field-programmable gate arrays (FPGAs), classical processors, application-specific integrated circuits (ASICs), signal conditioning circuitry, etc. In some embodiments, some or all of the quantum/classical interface circuitry 208 may be inside of a refrigerator, such as a dilution refrigerator, a magnetic refrigerator, a helium-4 and/or helium-3 refrigerator, etc. Some or all of the components of the quantum/classical interface circuitry 208 may be at any suitable temperature, such as 10 millikelvin, 100 millikelvin, 4 Kelvin, 20 Kelvin, 77 Kelvin, room temperature or above, or anywhere in between.

The quantum processor 210 is configured to operate one or more qubits. The qubits may be any suitable type of qubit, such as a quantum dot spin qubit described above in regard to FIGS. 1A-1F. In other embodiments, the qubits may be, e.g., charge qubits, transmon qubits, microwave qubits, superconducting qubits, or any other suitable type of qubits. The quantum processor 210 may include any suitable number of physical or logical qubits, such as 1-10⁶. In the illustrative embodiment, some or all of the quantum processor 210 is in a refrigerator such as a dilution refrigerator. In particular, in the illustrative embodiment, the qubits are held at a temperature of about 10 millikelvin. In other embodiments, the qubits may be held at any suitable temperature, such as 1-100 millikelvin or higher, depending on the temperature sensitivity of the particular qubit in use.

The quantum processor 210 may be able to control the various qubits in various ways, such as by performing two-qubit gates, three-qubit gates, error correction operations, transferring a state from one type of qubit to another, measuring some, any, or all of the qubits, initializing some, any, or all of the qubits, etc.

The quantum compute device 200 may include additional components not shown in FIG. 2, such as one or more data storage devices, a network interface controller, one or more peripheral devices, etc.

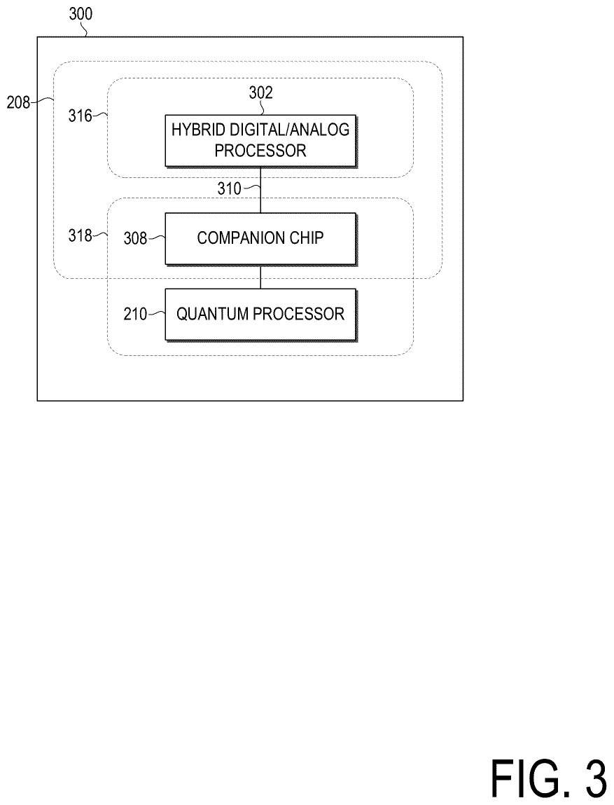

Referring now to FIG. 3, in one embodiment, the quantum processor 210 and some or all of the quantum/classical interface circuitry 208 may be in a cryogenic refrigerator 300. The quantum/classical interface circuitry 208 includes a hybrid digital/analog processor 302 that can interface with a companion chip 308. The hybrid digital/analog processor 302 may also be referred to as an auxiliary processor, an ancillary processor, or simply a processor. The hybrid digital/analog processor 302 may be connected to the companion chip 308 by one or more wires 310. The wires 310 may be embodied as one or more cables, buses, twisted wire pairs, etc.

In the illustrative embodiment, the hybrid digital/analog processor 302 may be in a first stage 316 of the cryogenic refrigerator 300, and the companion chip 308 and the quantum processor 210 may be in a second stage 318 of the cryogenic refrigerator 300. In the illustrative embodiment, the first stage 316 is held at a temperature of about 4 Kelvin, and the second stage 318 is held at a temperature of about 20 millikelvin. In other embodiments, the first stage 316 may be held at, e.g., 1-77 Kelvin, and the second stage 318 may be held at, e.g., 10-100 millikelvin. In some embodiments, the various components of FIG. 3 may be in different stages than that shown in FIG. 3 and/or the refrigerator 300 may include additional stages, such as one or more stages at a higher or lower temperature than the first stage 316 and/or the second stage 318. The cryogenic refrigerator 300 may be any suitable refrigerator with active or passive cooling, such as a dilution refrigerator, a magnetic refrigerator, a helium-4 and/or helium-3 refrigerator, etc.

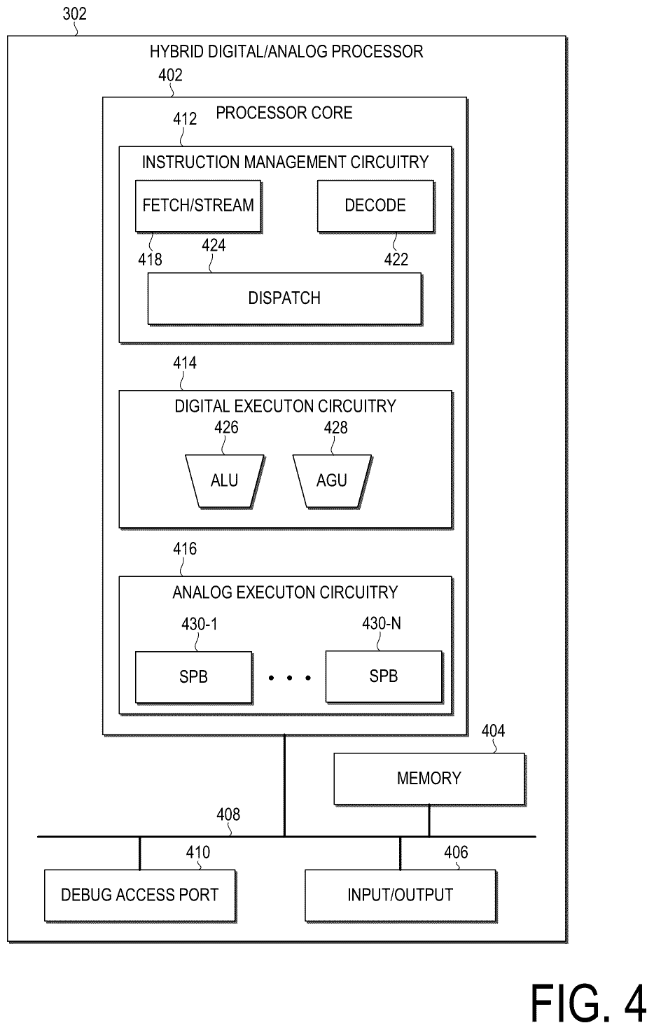

In use and as described in more detail below in regard to FIGS. 4-6, the hybrid digital/analog processor 302 receives instructions from another component of the quantum compute device 200 (e.g., from the processor 202 or the memory 204). The instructions may be digital instructions, such as read from or write to memory, read from or write to a register, conditional branches, etc. The instructions may also be analog instructions, such as an instruction to generate or receive an analog pulse, set an analog voltage on a qubit, set a digital voltage on a multiplexer that selects a qubit, etc. The hybrid digital/analog processor 302 may send and receive digital and/or analog signals to the companion chip 308. Signals for multiple qubits may be sent on the wires 310 from the hybrid digital/analog processor 302 to the companion chip 308, and the companion chip 308 may demultiplex signals from the hybrid digital/analog processor 302, such as by using frequency multiplexing, temporal multiplexing, etc. As such, the hybrid digital/analog processor 302 may send and receive analog signals to a relatively large number of qubits over a relatively small number of wires 310. For example, for each wire 310 carrying analog signals to and from the hybrid digital/analog processor 302, the hybrid digital/analog processor 302 may control 2-100 qubits. Additionally or alternatively, in some embodiments, the hybrid digital/analog processor 302 may send and receive analog and/or digital signals directly to or from the quantum processor 210, without necessarily going through the companion chip 308.

Referring now to FIG. 4, in one embodiment, a hybrid digital/analog processor 302 includes a processor core 402, memory 404, input/output (I/O) 406, an interconnect 408, and a debug access port (DAP) 410. The processor core 402 includes instruction management circuitry 412, digital execution circuitry 414, and analog execution circuitry 416. In the illustrative embodiment, the hybrid digital/analog processor 302 is based on a von Neumann architecture. In the illustrative embodiment, the hybrid digital/analog processor 302 is embodied as an integrated circuit package with one or more semiconductor dies, one or more circuit boards with interconnect layers, etc. The hybrid digital/analog processor 302 may be embodied as a system-on-a-chip. The hybrid digital/analog processor 302 may employ an architecture with any suitable number of bits, such as a 32-bit or 64-bit architecture. The instruction set of the hybrid digital/analog processor 302 includes both digital and analog instructions and may be an extension or modification of an existing instruction set, such as x86, or may be different instruction set.

The memory 404 may be embodied as any suitable type or amount of memory, such as one or more levels of SRAM cache. The I/O 406 allows for digital input and output to and from the hybrid digital/analog processor 302. The interconnect 408 allows for communication between the various components of the hybrid digital/analog processor 302. The DAP 410 allows for debugging of operations on the hybrid digital/analog processor 302.

The instruction management circuitry 412 include a fetch/stream module 418, a decode module 422, and a dispatch module 424. The fetch/stream module 418 fetches or streams the next instruction or set of instructions. The fetch/stream module 418 may receive instructions from the on-processor memory 404 or from another component of the quantum compute device 200, such as the processor 202 or the memory 204. The decode module 422 is configured to decode instructions and determine what the instruction is and, in particular, whether it should be executed by the digital execution circuitry 414 or by the analog execution circuitry 416. The dispatch module 424 sends the instructions to the digital execution circuitry 414 or to the analog execution circuitry 416, as appropriate.

The digital execution circuitry 414 is to execute digital instructions. The digital instructions may be, e.g., read from or write to memory (e.g., memory 404 or memory 204), read from or write to a register (e.g., registers in the core 402), conditional branches, etc. The digital instructions may be arithmetic operations that can be executed by an arithmetic logic unit (ALU) 426. For instructions transferring data to or more memory, an address generation unit (AGU) 428 may be used to calculate addresses used to access the main memory 204. In some cases, digital instructions may be used to write parameters to registers that are used in generating analog pulses as part of executing an analog instruction.

The analog execution circuitry 416 is to execute analog instructions. The analog execution circuitry includes one or more signal processing blocks (SPBs) 430. The SPBs 430 may also be referred to as digital signal processors (DSPs) 430. In the illustrative embodiment, each SPB 430 can send or receive signals to the companion chip 308 and to the quantum processor using the wires 310. The signals sent to the companion chip 308 may be, e.g., analog pulses to perform an operation on a qubit, analog voltages to control DC voltages applied to a qubit, digital voltages to select a qubit through multiplexing, etc. The signals received from the companion chip 308 may be, e.g., reflections of signals sent to qubits that indicate a state of the qubit. In some embodiments, each SPB 430 may send or receive signals for several qubits, such as 2-100. A SPB 430 may send or receive signals for more than one qubit on a single wire 310 or set of wires 310 using multiplexing, such as frequency and/or temporal multiplexing. An analog instruction may be to, e.g., create or measure an analog pulse. In some embodiments, an instruction may cause the SPB 430 to first create an analog pulse that is sent to qubit on the quantum processor and then measure a reflected or returned signal. In some embodiments, parameters of a pulse may be loaded into registers using digital instructions before the analog instruction is executed. For example, in one embodiment, digital instructions may load values into registers for a frequency of a pulse, an amplitude of a pulse, a phase of a pulse, an envelope of a pulse, etc. An analog instruction may then instruct a SPB 430 to generate a pulse based on the parameters stored in the registers. In the illustrative embodiment, the SPBs 430 have direct access to analog input and output channels of the hybrid digital/analog processor 302.

The SPBs 430 may create voltages or pulses at any suitable wavelength, bandwidth, envelope (e.g., square or Gaussian), amplitude, etc. The SPBs 430 may generate square voltage pulses with a duration of, e.g., 1 nanosecond to 100 microseconds. The SPBs 430 may generate microwave pulses with a duration of, e.g., 1-100 nanoseconds. The microwaves pulses may be modulated on a carrier frequency of, e.g., 11-20 gigahertz with a bandwidth of, e.g., 1-100 megahertz. In order to measure a state of a qubit, a SPB 430 may generate one or more pulses with a center frequency of 50-1,000 MHz and a bandwidth of 2-20 MHz. The SPB 430 generating the pulse or a different SPB may measure a reflection of such a signal off of the qubit and infer a state of the qubit based on the reflection.

It should be appreciated that the timing of the analog signals is critical. As such, in some embodiments, some or all of the hybrid digital/analog processor 302 may operate in a timing-aware or a real-time mode, ensuring that signals sent to the quantum processor 210 are sent at the proper time.

In the illustrative embodiment, the analog execution circuitry 416 may not operate at the same clock rate as other components of the processor core 402, such as the digital execution circuitry 414. For example, the analog execution circuitry 416 may operate in a different clock domain and/or may operate at a different clock rate. In some embodiments, parts of the analog execution circuitry 416 may be powered down to reduce power usage.

In the illustrative embodiment, the processor core 402 of the hybrid digital/analog processor 302 may be able to control several qubits, such as 2-1,000 qubits. To do so, the processor core 402 may include several SPBs 430, such as 2-10. The SPBs 430 may perform operations on qubits at a relatively low rate, such as one operation per qubit every 20 nanoseconds. However, if the processor core 402 controls, e.g., 100 qubits, then the processor core 402 consumes one operation every 0.2 nanoseconds or at a rate of 5 gigahertz. In order to provide enough instructions to the processor core 402, the front end of the hybrid digital/analog processor may be relatively wide. For example, the hybrid digital/analog processor may receive, e.g., 5-20 instructions per clock cycle.

It should be appreciated that integrating the SPBs 430 into the processor core 402 can provide several advantages. As the SPBs 430 are integrated into the same die or package as other components of the processor core 402, the latency between the digital execution circuitry 414 and the analog execution circuitry 416 is reduced. For example, data handover from the digital and analog backends may happen within a few clock cycles, or less than one nanosecond. Additionally, the digital execution circuitry 414 and the analog execution circuitry 416 can share memory 404 and registers, further reducing latency required in copying data as well as reducing power used in memory storage. Any digital circuitry required to manage the SPBs 430 can be integrated with other digital circuitry in the processor core 402, reducing components in the SPBs 430. As the front-end for both digital and analog instructions are the same, a compiler may optimize a program at compile-time to run more efficiently on the hybrid digital/analog processor 302. Feedback from the quantum processor 210, such as conditional readouts, error correction readouts, etc., may be used to feed-forward to further operations on the quantum processor 210 with low latency, improving the performance of algorithms executed on the quantum processor 210.

It should be appreciated that the description of the hybrid digital/analog processor 302 is simplified, and that the hybrid digital/analog processor 302 may include additional components or circuitry commonly found in processors. For example, the hybrid digital/analog processor 302 may include a memory management unit (MMU), may use techniques such as pipelining, may execute instructions out of order, etc.

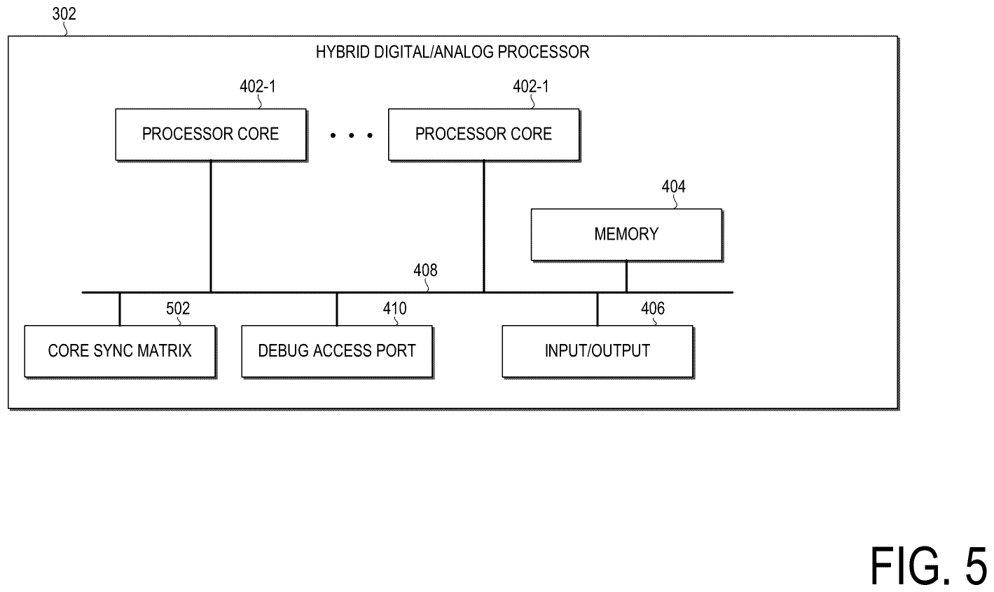

Referring now to FIG. 5, in some embodiments, it may be difficult for a single processor core 402 to perform all of the desired function of the hybrid digital/analog processor 302. For example, the hybrid digital/analog processor 302 may mange a large number of qubits, such as 100-1,000 qubits, and the single processor core 402 may not be able to add more SPBs 430 without suffering performance loss. In such an embodiment, the hybrid digital/analog processor 302 may include more than one processor core 402, as shown in FIG. 5. The hybrid digital/analog processor 302 may include any suitable number of processor cores 402, such as 1-20. A multi-core hybrid digital/analog processor 302 may include a core sync matrix 502 to synchronize timing between the various processor core 402 and, in particular, between the various SPBs 430.

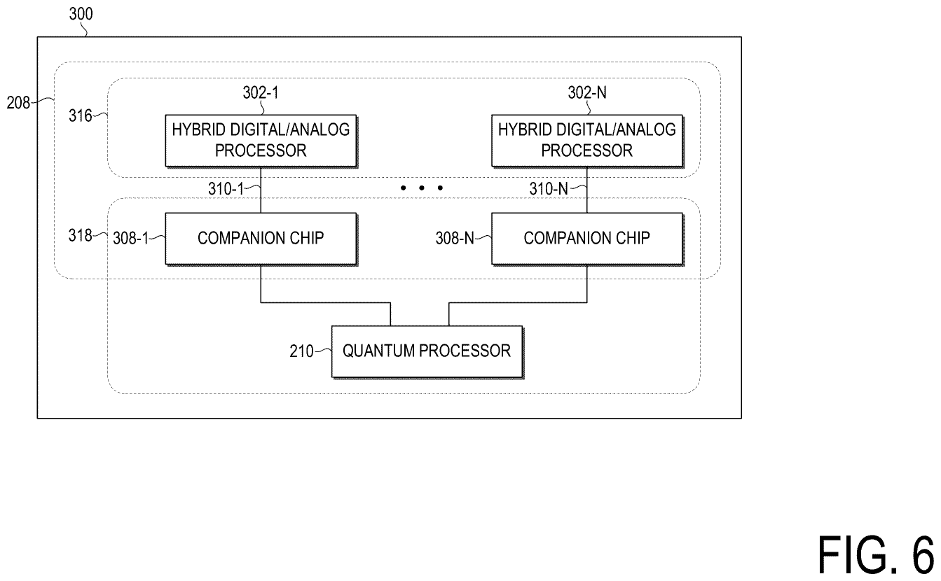

Referring now to FIG. 6, in some embodiments, it may be difficult for a single hybrid digital/analog processor 302 to control the desired number of qubits of a quantum processor 210, even for a hybrid digital/analog processor 302 with multiple cores 402. For example, the hybrid digital/analog processor 302 may mange a large number of qubits, such as 1,000-10,000 qubits, and the single hybrid digital/analog processor 302 may not be able to add more processor cores 402 without suffering performance loss or a lower yield. In such an embodiment, the quantum/classical interface circuitry 208 may include more than one hybrid digital/analog processor 302, as shown in FIG. 6. The quantum/classical interface circuitry 208 may include any suitable number of hybrid digital/analog processors 302, such as 1-20. The core sync matrix 502 in each hybrid digital/analog processors 302 may synchronize between hybrid digital/analog processors as well as between processor cores 402. In the illustrative embodiment, each hybrid digital/analog processor 302 has a corresponding companion chip 308, and the various companion chips 308 interface with different qubits on the same quantum processor 210.

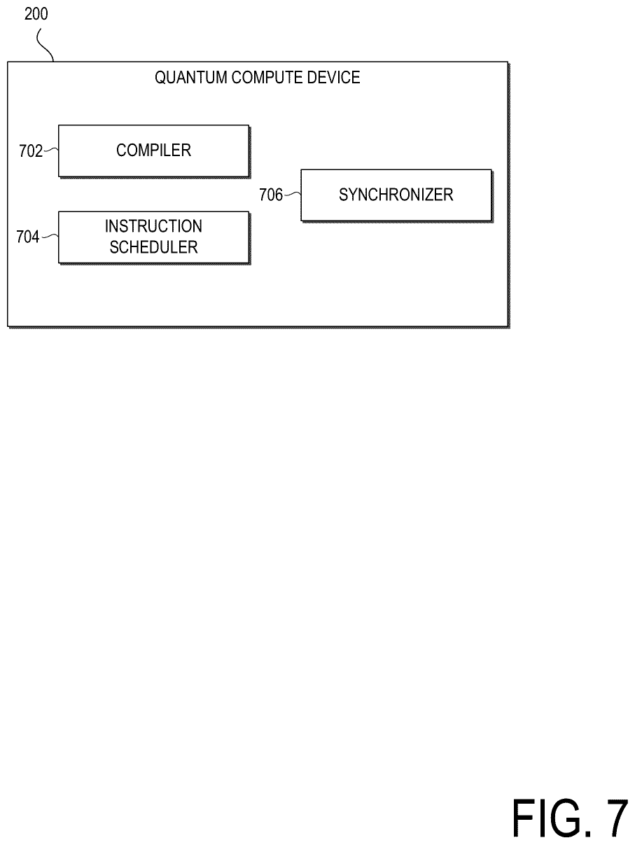

Referring now to FIG. 7, in an illustrative embodiment, the quantum compute device 200 establishes an environment 700 during operation. The illustrative environment 700 includes a compiler 702, an instruction scheduler 704, and a synchronizer 706. The various modules of the environment 700 may be embodied as hardware, software, firmware, or a combination thereof. For example, the various modules, logic, and other components of the environment 700 may form a portion of, or otherwise be established by, the processor 202, the memory 204, data storage, or other hardware components of the quantum compute device 200. As such, in some embodiments, one or more of the modules of the environment 700 may be embodied as circuitry or collection of electrical devices (e.g., compiler circuitry 702, instruction scheduler circuitry 704, synchronizer circuitry 706, etc.). It should be appreciated that, in such embodiments, one or more of the circuits (e.g., the compiler circuitry 702, the instruction scheduler circuitry 704, the synchronizer circuitry 706, etc.) may form a portion of one or more of the processor 202, the memory 204, the data storage, and/or other components of the quantum compute device 200. For example, in some embodiments, some or all of the modules may be embodied as the processor 202, the memory 204, and/or data storage storing instructions to be executed by the processor 202. Additionally, in some embodiments, one or more of the illustrative modules may form a portion of another module and/or one or more of the illustrative modules may be independent of one another. Further, in some embodiments, one or more of the modules of the environment 700 may be embodied as virtualized hardware components or emulated architecture, which may be established and maintained by the processor 202 or other components of the quantum compute device 200. It should be appreciated that some of the functionality of one or more of the modules of the environment 700 may require a hardware implementation, in which case embodiments of modules that implement such functionality will be embodied at least partially as hardware.

The compiler 702, which may be embodied as hardware, firmware, software, virtualized hardware, emulated architecture, and/or a combination thereof as discussed above, is configured to compile a program to be executed by the processor 202, the hybrid digital/analog processor 302, and the quantum processor 210. In the illustrative embodiment, the compiler 702 may optimize the compiled code based on the capabilities of the hybrid digital/analog processor 302. The optimization may reduce or eliminate idle time for the hybrid digital/analog processors 302, the cores 402, the SPBs 430, etc.

The instruction scheduler 704, which may be embodied as hardware, firmware, software, virtualized hardware, emulated architecture, and/or a combination thereof as discussed above, is configured to schedule instructions on one or more hybrid digital/analog processor 302. The instructions may be digital or analog instructions. The instructions may be to, e.g., initialize some or all of the qubits in the quantum processor 210, perform one or more operations on the qubits, and read a value from one or more of the qubits. The instruction scheduler 704 may coordinate scheduling of operations on different SPBs 430, on different cores 402, and on different hybrid digital/analog processors 302. The instruction scheduler 704 may have various options for channel assignment within a given hybrid digital/analog processor 302 as well as across the various hybrid digital/analog processors 302.

The instruction scheduler 704 is configured to receive feedback data from the hybrid digital/analog processors 302, such as readout data from qubits of the quantum processor 210. As computational power and cooling ability may be limited on the hybrid digital/analog processor 302, part of the algorithm for controlling the qubits of the quantum processor 210 may be performed on the processor 202, particularly if latency is not critical. The instruction scheduler 704 may determine what operations should be performed on the quantum processor 210 based on measurements on the qubits, and the instruction scheduler 704 may send instructions and/or data to the hybrid digital/analog processor 302 based on the measurements on the qubits.

The synchronizer 706 can manage synchronization between the various cores 402, SPBs, 430, etc., of one or more hybrid digital/analog processor 302. The synchronizer 706 may communicate with the various core sync matrices 502 of the hybrid digital/analog processors 302.

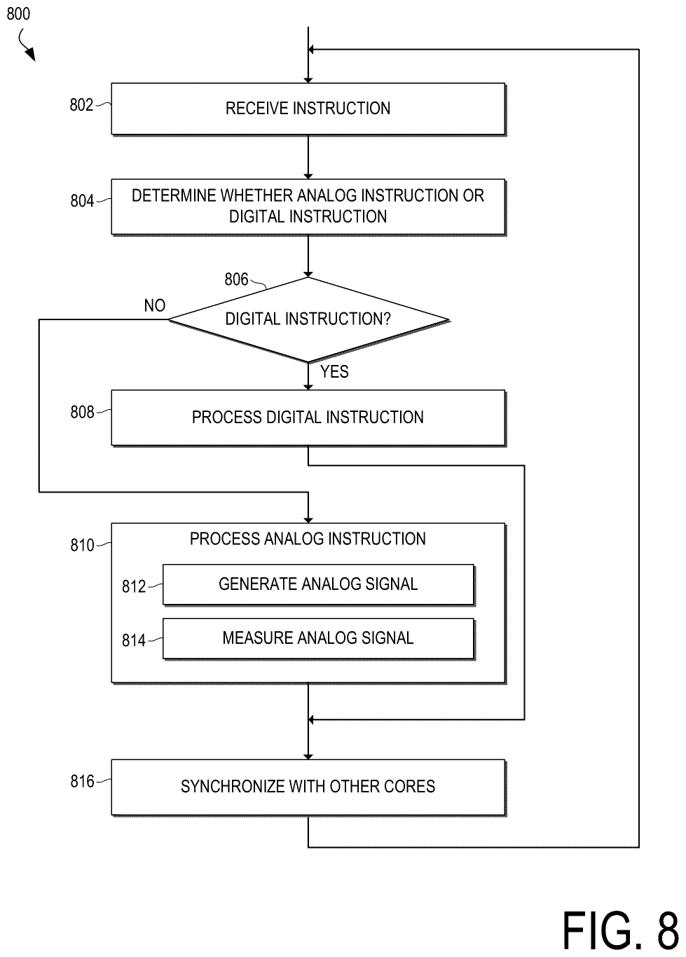

Referring now to FIG. 8, in one embodiment, a flowchart for a method 800 for executing instructions of the hybrid digital/analog processor 302 is shown. The method 800 begins in block 802, in which the hybrid digital/analog processor 302 receives an instruction. The hybrid digital/analog processor 302 may receive instructions from, e.g., the processor 202, the memory 204, the memory 404, etc.

In block 804, the hybrid digital/analog processor 302 determines whether the instruction is a digital or analog instruction. The hybrid digital/analog processor 302 may examine decode microcode in the instruction to determine whether the instruction is a digital or analog instruction. For example, instructions with certain microcode may be assigned to the digital execution circuitry 414, and instructions with certain microcode may be assigned to the analog execution circuitry 416.

In block 806, if the instruction is a digital instruction, the method 800 proceeds to block 808, in which the instruction is passed to the digital execution circuitry 414, and the digital execution circuitry 414 executes the instruction. The instruction may be, e.g., a read or write to memory operation, a read or write to a register operation, an arithmetic operation, a conditional branch, etc. The method 800 then jumps to block 816, in which the hybrid digital/analog processor 302 synchronizes between cores 402 and, in some embodiments, synchronizes with other hybrid digital/analog processor 302. The method 800 then loops back to block 802 to receive another instruction.

Referring back to block 806, if the instruction is not a digital instruction, the method 800 jumps to block 810, in which the instruction is passed to the analog execution circuitry 416, and the analog execution circuitry 416 executes the instruction. In block 812, the analog execution circuitry 416 may generate an analog signal such as a radiofrequency pulse. The analog execution circuitry 416 may use values stored in registers to generate the analog signal, such as registers that indicate an amplitude, frequency, envelope, etc. In block 814, the analog execution circuitry 416 may measure an analog signal, such as a reflection of an RF signal sent to a qubit. In some embodiments, generating an analog signal and measuring the reflection may be performed as a single instruction. The method 800 then proceeds to block 816 to synchronize with other cores 402 and/or other hybrid digital/analog processors 302.

It should be appreciated that the method 800 illustrates a simplified flow of the hybrid digital/analog processor 302, and that, in some embodiments, a flow of the hybrid digital/analog processor 302 may include additional steps, may perform steps out of order, etc. For example, in some embodiments, the hybrid digital/analog processor 302 may use pipelining and/or may perform certain instructions out of order.

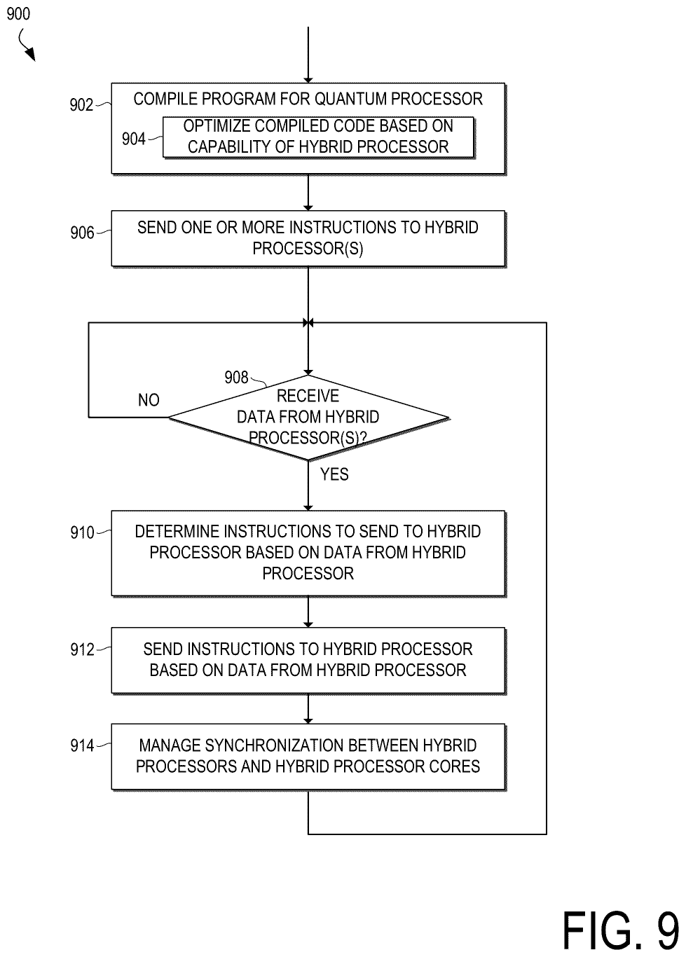

Referring now to FIG. 9, in one embodiment, a flowchart for a method 900 for executing a program on the quantum processor 210 is shown. The method 900 may be performed by components of the quantum compute device 200, such as the processor 202, the memory 204, compiler 702, the instruction scheduler 704, the synchronizer 706, etc. The method 900 begins in block 902, in which the quantum compute device 200 compiles a program to be executed by the processor 202, the hybrid digital/analog processor 302, and the quantum processor 210. In the illustrative embodiment, the compiler may optimize the compiled code based on the capabilities of the hybrid digital/analog processor 302. The optimization may reduce or eliminate idle time for the hybrid digital/analog processors 302, the cores 402, the SPBs 430, etc.

In block 906, the processor 202 sends one or more instructions to one or more hybrid digital/analog processor 302. The instructions may be digital or analog instructions. The instructions may be to, e.g., initialize some or all of the qubits in the quantum processor 210, perform one or more operations on the qubits, and read a value from one or more of the qubits. The processor 202 may coordinate scheduling of operations on different SPBs 430, on different cores 402, and on different hybrid digital/analog processors 302. The processor 202 may have various options for channel assignment within a given hybrid digital/analog processor 302 as well as across the various hybrid digital/analog processors 302.

In block 908, if the processor 202 has not received data from the hybrid digital/analog processor 302, such as measurement data of one or more qubits, the method 900 loops back to block 908 to continue waiting for results from the hybrid digital/analog processor 302. If the processor 202 does receive data from the hybrid digital/analog processor 302, the method 900 proceeds to block 910.

In block 910, the processor 202 determines what instructions to send to the hybrid digital/analog processor 302. As computational power and cooling ability may be limited on the hybrid digital/analog processor 302, part of the algorithm for controlling the qubits of the quantum processor 210 may be performed on the processor 202, particularly if latency is not critical. The processor 202 may determine what operations should be performed on the quantum processor 210 based on measurements on the qubits, and the processor 202 may send instructions and/or data to the hybrid digital/analog processor 302 based on the measurements on the qubits. In block 912, the processor 202 sends instructions and/or data to the hybrid digital/analog processor 302.

In block 914, the processor 202 can manage synchronization between the various cores 402 of one or more hybrid digital/analog processor 302. The method 900 then loops back to block 908 to wait to receive more data from the hybrid digital/analog processor 302.

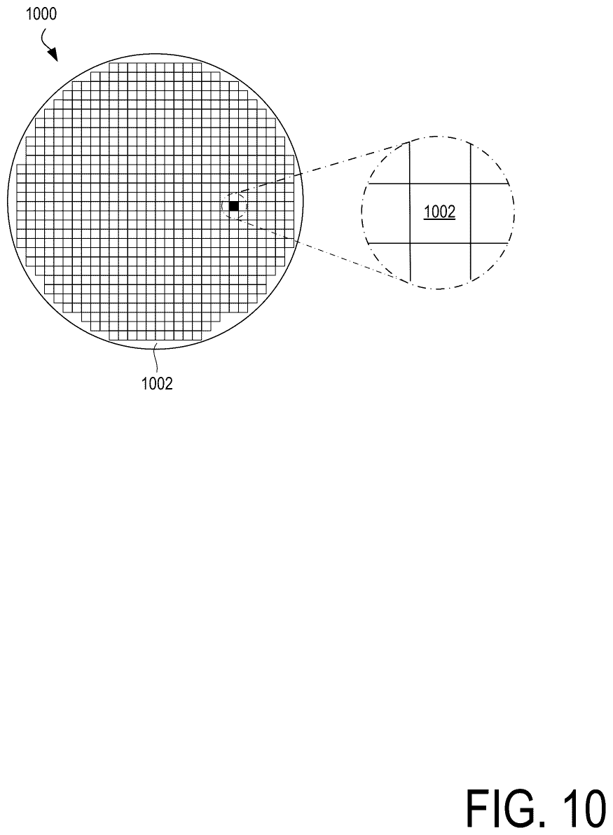

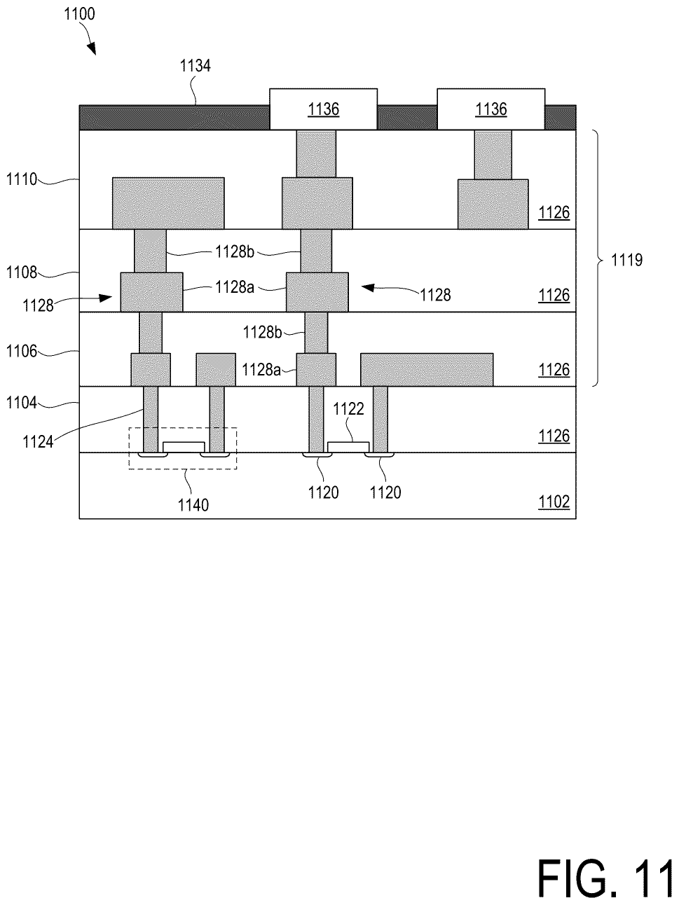

FIG. 10 is a top view of a wafer 1000 and dies 1002 that may be included in any of the processors disclosed herein (e.g., as any suitable ones of the dies of the processor 202, the hybrid digital/analog processor 302, or the quantum processor 210). The wafer 1000 may be composed of semiconductor material and may include one or more dies 1002 having integrated circuit structures formed on a surface of the wafer 1000. The individual dies 1002 may be a repeating unit of an integrated circuit product that includes any suitable integrated circuit. After the fabrication of the semiconductor product is complete, the wafer 1000 may undergo a singulation process in which the dies 1002 are separated from one another to provide discrete “chips” of the integrated circuit product. The die 1002 may be any of the dies of the processors disclosed herein, such as the processor 202, the hybrid digital/analog processor 302, or the quantum processor 210. The die 1002 may include one or more transistors (e.g., some of the transistors 1140 of FIG. 11, discussed below), supporting circuitry to route electrical signals to the transistors, passive components (e.g., signal traces, resistors, capacitors, or inductors), and/or any other integrated circuit components. In some embodiments, the wafer 1000 or the die 1002 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 1002. For example, a memory array formed by multiple memory devices may be formed on a same die 1002 as a processor unit (e.g., the processor unit 1402 of FIG. 14) or other logic that is configured to store information in the memory devices or execute instructions stored in the memory array. Various ones of the processors (such as the processor 202, the hybrid digital/analog processor 302, or the quantum processor 210) disclosed herein may be manufactured using a die-to-wafer assembly technique in which some dies are attached to a wafer 1000 that include others of the dies, and the wafer 1000 is subsequently singulated.

FIG. 11 is a cross-sectional side view of an integrated circuit device 1100 that may be included in any of the processors (such as the processor 202, the hybrid digital/analog processor 302, or the quantum processor 210 disclosed herein. One or more of the integrated circuit devices 1100 may be included in one or more dies 1002 (FIG. 10). The integrated circuit device 1100 may be formed on a die substrate 1102 (e.g., the wafer 1000 of FIG. 10) and may be included in a die (e.g., the die 1002 of FIG. 10). The die substrate 1102 may be a semiconductor substrate composed of semiconductor material systems including, for example, n-type or p-type materials systems (or a combination of both). The die substrate 1102 may include, for example, a crystalline substrate formed using a bulk silicon or a silicon-on-insulator (SOI) substructure. In some embodiments, the die substrate 1102 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 1102. Although a few examples of materials from which the die substrate 1102 may be formed are described here, any material that may serve as a foundation for an integrated circuit device 1100 may be used. The die substrate 1102 may be part of a singulated die (e.g., the dies 1002 of FIG. 10) or a wafer (e.g., the wafer 1000 of FIG. 10).

The integrated circuit device 1100 may include one or more device layers 1104 disposed on the die substrate 1102. The device layer 1104 may include features of one or more transistors 1140 (e.g., metal oxide semiconductor field-effect transistors (MOSFETs)) formed on the die substrate 1102. The transistors 1140 may include, for example, one or more source and/or drain (S/D) regions 1120, a gate 1122 to control current flow between the S/D regions 1120, and one or more S/D contacts 1124 to route electrical signals to/from the S/D regions 1120. The transistors 1140 may include additional features not depicted for the sake of clarity, such as device isolation regions, gate contacts, and the like. The transistors 1140 are not limited to the type and configuration depicted in FIG. 11 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

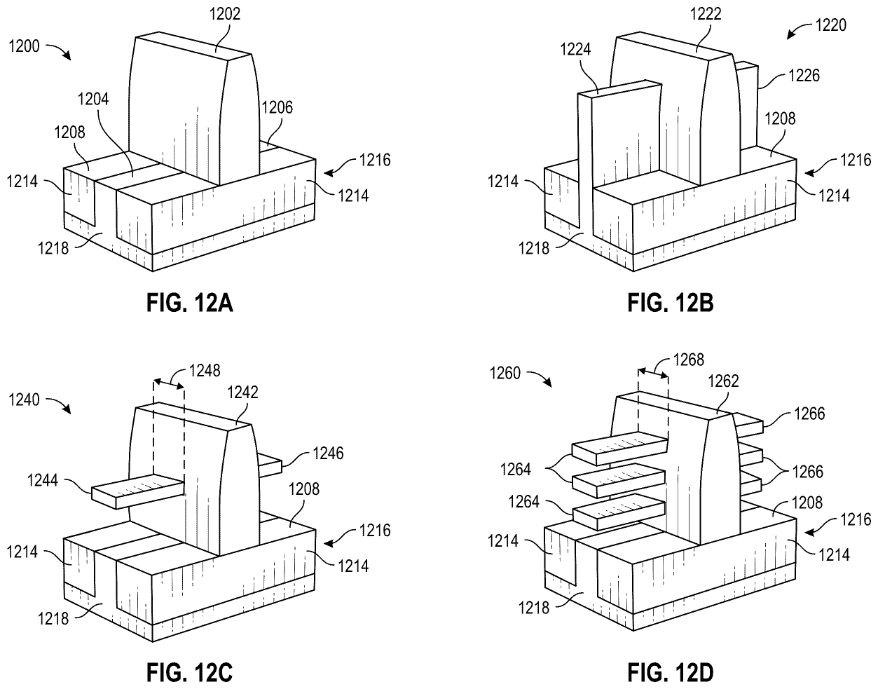

FIGS. 12A-12D are simplified perspective views of example planar, FinFET, gate-all-around, and stacked gate-all-around transistors. The transistors illustrated in FIGS. 12A-12D are formed on a substrate 1216 having a surface 1208. Isolation regions 1214 separate the source and drain regions of the transistors from other transistors and from a bulk region 1218 of the substrate 1216.

FIG. 12A is a perspective view of an example planar transistor 1200 comprising a gate 1202 that controls current flow between a source region 1204 and a drain region 1206. The transistor 1200 is planar in that the source region 1204 and the drain region 1206 are planar with respect to the substrate surface 1208.

FIG. 12B is a perspective view of an example FinFET transistor 1220 comprising a gate 1222 that controls current flow between a source region 1224 and a drain region 1226. The transistor 1220 is non-planar in that the source region 1224 and the drain region 1226 comprise “fins” that extend upwards from the substrate surface 1228. As the gate 1222 encompasses three sides of the semiconductor fin that extends from the source region 1224 to the drain region 1226, the transistor 1220 can be considered a tri-gate transistor. FIG. 12B illustrates one S/D fin extending through the gate 1222, but multiple S/D fins can extend through the gate of a FinFET transistor.

FIG. 12C is a perspective view of a gate-all-around (GAA) transistor 1240 comprising a gate 1242 that controls current flow between a source region 1244 and a drain region 1246. The transistor 1240 is non-planar in that the source region 1244 and the drain region 1246 are elevated from the substrate surface 1228.

FIG. 12D is a perspective view of a GAA transistor 1260 comprising a gate 1262 that controls current flow between multiple elevated source regions 1264 and multiple elevated drain regions 1266. The transistor 1260 is a stacked GAA transistor as the gate controls the flow of current between multiple elevated S/D regions stacked on top of each other. The transistors 1240 and 1260 are considered gate-all-around transistors as the gates encompass all sides of the semiconductor portions that extends from the source regions to the drain regions. The transistors 1240 and 1260 can alternatively be referred to as nanowire, nanosheet, or nanoribbon transistors depending on the width (e.g., widths 1248 and 1268 of transistors 1240 and 1260, respectively) of the semiconductor portions extending through the gate.

Returning to FIG. 11, a transistor 1140 may include a gate 1122 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 1140 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 1140 along the source-channel-drain direction, the gate electrode may consist of a U-shaped structure that includes a bottom portion substantially parallel to the surface of the die substrate 1102 and two sidewall portions that are substantially perpendicular to the top surface of the die substrate 1102. In other embodiments, at least one of the metal layers that form the gate electrode may simply be a planar layer that is substantially parallel to the top surface of the die substrate 1102 and does not include sidewall portions substantially perpendicular to the top surface of the die substrate 1102. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 1120 may be formed within the die substrate 1102 adjacent to the gate 1122 of individual transistors 1140. The S/D regions 1120 may be formed using an implantation/diffusion process or an etching/deposition process, for example. In the former process, dopants such as boron, aluminum, antimony, phosphorous, or arsenic may be ion-implanted into the die substrate 1102 to form the S/D regions 1120. An annealing process that activates the dopants and causes them to diffuse farther into the die substrate 1102 may follow the ion-implantation process. In the latter process, the die substrate 1102 may first be etched to form recesses at the locations of the S/D regions 1120. An epitaxial deposition process may then be carried out to fill the recesses with material that is used to fabricate the S/D regions 1120. In some implementations, the S/D regions 1120 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 1120 may be formed using one or more alternate semiconductor materials such as germanium or a group III-V material or alloy. In further embodiments, one or more layers of metal and/or metal alloys may be used to form the S/D regions 1120.

Electrical signals, such as power and/or input/output (I/O) signals, may be routed to and/or from the devices (e.g., transistors 1140) of the device layer 1104 through one or more interconnect layers disposed on the device layer 1104 (illustrated in FIG. 11 as interconnect layers 1106-1110). For example, electrically conductive features of the device layer 1104 (e.g., the gate 1122 and the S/D contacts 1124) may be electrically coupled with the interconnect structures 1128 of the interconnect layers 1106-1110. The one or more interconnect layers 1106-1110 may form a metallization stack (also referred to as an “ILD stack”) 1119 of the integrated circuit device 1100.

The interconnect structures 1128 may be arranged within the interconnect layers 1106-1110 to route electrical signals according to a wide variety of designs; in particular, the arrangement is not limited to the particular configuration of interconnect structures 1128 depicted in FIG. 11. Although a particular number of interconnect layers 1106-1110 is depicted in FIG. 11, embodiments of the present disclosure include integrated circuit devices having more or fewer interconnect layers than depicted.

In some embodiments, the interconnect structures 1128 may include lines 1128a and/or vias 1128b filled with an electrically conductive material such as a metal. The lines 1128a may be arranged to route electrical signals in a direction of a plane that is substantially parallel with a surface of the die substrate 1102 upon which the device layer 1104 is formed. For example, the lines 1128a may route electrical signals in a direction in and out of the page and/or in a direction across the page. The vias 1128b may be arranged to route electrical signals in a direction of a plane that is substantially perpendicular to the surface of the die substrate 1102 upon which the device layer 1104 is formed. In some embodiments, the vias 1128b may electrically couple lines 1128a of different interconnect layers 1106-1110 together.

The interconnect layers 1106-1110 may include a dielectric material 1126 disposed between the interconnect structures 1128, as shown in FIG. 11. In some embodiments, dielectric material 1126 disposed between the interconnect structures 1128 in different ones of the interconnect layers 1106-1110 may have different compositions; in other embodiments, the composition of the dielectric material 1126 between different interconnect layers 1106-1110 may be the same. The device layer 1104 may include a dielectric material 1126 disposed between the transistors 1140 and a bottom layer of the metallization stack as well. The dielectric material 1126 included in the device layer 1104 may have a different composition than the dielectric material 1126 included in the interconnect layers 1106-1110; in other embodiments, the composition of the dielectric material 1126 in the device layer 1104 may be the same as a dielectric material 1126 included in any one of the interconnect layers 1106-1110.

A first interconnect layer 1106 (referred to as Metal 1 or “M1”) may be formed directly on the device layer 1104. In some embodiments, the first interconnect layer 1106 may include lines 1128a and/or vias 1128b, as shown. The lines 1128a of the first interconnect layer 1106 may be coupled with contacts (e.g., the S/D contacts 1124) of the device layer 1104. The vias 1128b of the first interconnect layer 1106 may be coupled with the lines 1128a of a second interconnect layer 1108.

The second interconnect layer 1108 (referred to as Metal 2 or “M2”) may be formed directly on the first interconnect layer 1106. In some embodiments, the second interconnect layer 1108 may include via 1128b to couple the lines 1128 of the second interconnect layer 1108 with the lines 1128a of a third interconnect layer 1110. Although the lines 1128a and the vias 1128b are structurally delineated with a line within individual interconnect layers for the sake of clarity, the lines 1128a and the vias 1128b may be structurally and/or materially contiguous (e.g., simultaneously filled during a dual-damascene process) in some embodiments.

The third interconnect layer 1110 (referred to as Metal 3 or “M3”) (and additional interconnect layers, as desired) may be formed in succession on the second interconnect layer 1108 according to similar techniques and configurations described in connection with the second interconnect layer 1108 or the first interconnect layer 1106. In some embodiments, the interconnect layers that are “higher up” in the metallization stack 1119 in the integrated circuit device 1100 (i.e., farther away from the device layer 1104) may be thicker that the interconnect layers that are lower in the metallization stack 1119, with lines 1128a and vias 1128b in the higher interconnect layers being thicker than those in the lower interconnect layers.

The integrated circuit device 1100 may include a solder resist material 1134 (e.g., polyimide or similar material) and one or more conductive contacts 1136 formed on the interconnect layers 1106-1110. In FIG. 11, the conductive contacts 1136 are illustrated as taking the form of bond pads. The conductive contacts 1136 may be electrically coupled with the interconnect structures 1128 and configured to route the electrical signals of the transistor(s) 1140 to external devices. For example, solder bonds may be formed on the one or more conductive contacts 1136 to mechanically and/or electrically couple an integrated circuit die including the integrated circuit device 1100 with another component (e.g., a printed circuit board). The integrated circuit device 1100 may include additional or alternate structures to route the electrical signals from the interconnect layers 1106-1110; for example, the conductive contacts 1136 may include other analogous features (e.g., posts) that route the electrical signals to external components.

In some embodiments in which the integrated circuit device 1100 is a double-sided die, the integrated circuit device 1100 may include another metallization stack (not shown) on the opposite side of the device layer(s) 1104. This metallization stack may include multiple interconnect layers as discussed above with reference to the interconnect layers 1106-1110, to provide conductive pathways (e.g., including conductive lines and vias) between the device layer(s) 1104 and additional conductive contacts (not shown) on the opposite side of the integrated circuit device 1100 from the conductive contacts 1136.

In other embodiments in which the integrated circuit device 1100 is a double-sided die, the integrated circuit device 1100 may include one or more through silicon vias (TSVs) through the die substrate 1102; these TSVs may make contact with the device layer(s) 1104, and may provide conductive pathways between the device layer(s) 1104 and additional conductive contacts (not shown) on the opposite side of the integrated circuit device 1100 from the conductive contacts 1136. In some embodiments, TSVs extending through the substrate can be used for routing power and ground signals from conductive contacts on the opposite side of the integrated circuit device 1100 from the conductive contacts 1136 to the transistors 1140 and any other components integrated into the die 1100, and the metallization stack 1119 can be used to route I/O signals from the conductive contacts 1136 to transistors 1140 and any other components integrated into the die 1100.

Multiple integrated circuit devices 1100 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

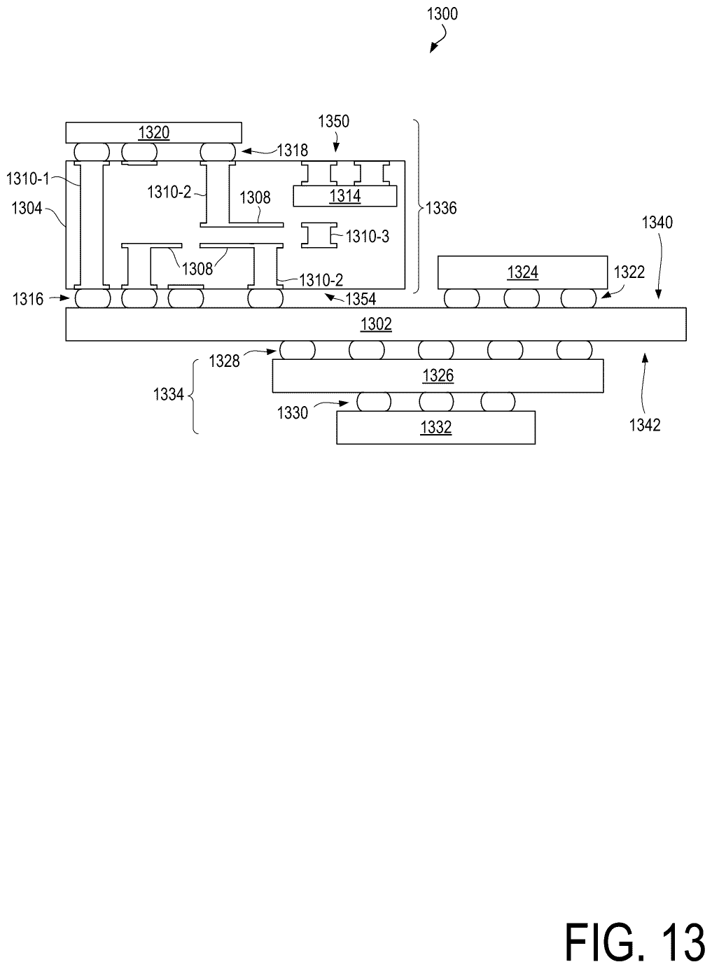

FIG. 13 is a cross-sectional side view of an integrated circuit device assembly 1300 that may include any of the processors (such as the processor 202, the hybrid digital/analog processor 302, or the quantum processor 210) disclosed herein. In some embodiments, the integrated circuit device assembly 1300 may be a processor 202, a hybrid digital/analog processor 302, or a quantum processor 210. The integrated circuit device assembly 1300 includes a number of components disposed on a circuit board 1302 (which may be a motherboard, system board, mainboard, etc.). The integrated circuit device assembly 1300 includes components disposed on a first face 1340 of the circuit board 1302 and an opposing second face 1342 of the circuit board 1302; generally, components may be disposed on one or both faces 1340 and 1342. Any of the integrated circuit components discussed below with reference to the integrated circuit device assembly 1300 may take the form of any suitable ones of the embodiments of the processors (such as the processor 202, the hybrid digital/analog processor 302, or the quantum processor 210) disclosed herein.

In some embodiments, the circuit board 1302 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1302. In other embodiments, the circuit board 1302 may be a non-PCB substrate. The integrated circuit device assembly 1300 illustrated in FIG. 13 includes a package-on-interposer structure 1336 coupled to the first face 1340 of the circuit board 1302 by coupling components 1316. The coupling components 1316 may electrically and mechanically couple the package-on-interposer structure 1336 to the circuit board 1302, and may include solder balls (as shown in FIG. 13), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 1336 may include an integrated circuit component 1320 coupled to an interposer 1304 by coupling components 1318. The coupling components 1318 may take any suitable form for the application, such as the forms discussed above with reference to the coupling components 1316. Although a single integrated circuit component 1320 is shown in FIG. 13, multiple integrated circuit components may be coupled to the interposer 1304; indeed, additional interposers may be coupled to the interposer 1304. The interposer 1304 may provide an intervening substrate used to bridge the circuit board 1302 and the integrated circuit component 1320.

The integrated circuit component 1320 may be a packaged or unpacked integrated circuit product that includes one or more integrated circuit dies (e.g., the die 1002 of FIG. 10, the integrated circuit device 1100 of FIG. 11) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 1320, a single monolithic integrated circuit die comprises solder bumps attached to contacts on the die. The solder bumps allow the die to be directly attached to the interposer 1304. The integrated circuit component 1320 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 1320 can comprise one or more additional active or passive devices such as capacitors, decoupling capacitors; resistors, inductors, fuses, diodes, transformers, sensors, electrostatic discharge (ESD) devices, and memory devices.

In embodiments where the integrated circuit component 1320 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 1320 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 1304 may spread connections to a wider pitch or reroute a connection to a different connection. For example, the interposer 1304 may couple the integrated circuit component 1320 to a set of ball grid array (BGA) conductive contacts of the coupling components 1316 for coupling to the circuit board 1302. In the embodiment illustrated in FIG. 13, the integrated circuit component 1320 and the circuit board 1302 are attached to opposing sides of the interposer 1304; in other embodiments, the integrated circuit component 1320 and the circuit board 1302 may be attached to a same side of the interposer 1304. In some embodiments, three or more components may be interconnected by way of the interposer 1304.

In some embodiments, the interposer 1304 may be formed as a PCB, including multiple metal layers separated from one another by layers of dielectric material and interconnected by electrically conductive vias. In some embodiments, the interposer 1304 may be formed of an epoxy resin, a fiberglass-reinforced epoxy resin, an epoxy resin with inorganic fillers, a ceramic material, or a polymer material such as polyimide. In some embodiments, the interposer 1304 may be formed of alternate rigid or flexible materials that may include the same materials described above for use in a semiconductor substrate, such as silicon, germanium, and other group III-V and group IV materials. The interposer 1304 may include metal interconnects 1308 and vias 1310, including but not limited to through hole vias 1310-1 (that extend from a first face 1350 of the interposer 1304 to a second face 1354 of the interposer 1304), blind vias 1310-2 (that extend from the first or second faces 1350 or 1354 of the interposer 1304 to an internal metal layer), and buried vias 1310-3 (that connect internal metal layers).

In some embodiments, the interposer 1304 can comprise a silicon interposer. Through silicon vias (TSV) extending through the silicon interposer can connect connections on a first face of a silicon interposer to an opposing second face of the silicon interposer. In some embodiments, an interposer 1304 comprising a silicon interposer can further comprise one or more routing layers to route connections on a first face of the interposer 1304 to an opposing second face of the interposer 1304.

The interposer 1304 may further include embedded devices 1314, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1304. The package-on-interposer structure 1336 may take the form of any of the package-on-interposer structures known in the art. In embodiments where the interposer is a non-printed circuit board

The integrated circuit device assembly 1300 may include an integrated circuit component 1324 coupled to the first face 1340 of the circuit board 1302 by coupling components 1322. The coupling components 1322 may take the form of any of the embodiments discussed above with reference to the coupling components 1316, and the integrated circuit component 1324 may take the form of any of the embodiments discussed above with reference to the integrated circuit component 1320.

The integrated circuit device assembly 1300 illustrated in FIG. 13 includes a package-on-package structure 1334 coupled to the second face 1342 of the circuit board 1302 by coupling components 1328. The package-on-package structure 1334 may include an integrated circuit component 1326 and an integrated circuit component 1332 coupled together by coupling components 1330 such that the integrated circuit component 1326 is disposed between the circuit board 1302 and the integrated circuit component 1332. The coupling components 1328 and 1330 may take the form of any of the embodiments of the coupling components 1316 discussed above, and the integrated circuit components 1326 and 1332 may take the form of any of the embodiments of the integrated circuit component 1320 discussed above. The package-on-package structure 1334 may be configured in accordance with any of the package-on-package structures known in the art.

FIG. 14 is a block diagram of an example electrical device 1400 that may include one or more of the processors (such as the processor 202, the hybrid digital/analog processor 302, or the quantum processor 210) disclosed herein. For example, any suitable ones of the components of the electrical device 1400 may include one or more of the integrated circuit device assemblies 1300, integrated circuit components 1320, integrated circuit devices 1100, or integrated circuit dies 1002 disclosed herein, and may be arranged in any of the processors (such as the processor 202, the hybrid digital/analog processor 302, or the quantum processor 210) disclosed herein. A number of components are illustrated in FIG. 14 as included in the electrical device 1400, but any one or more of these components may be omitted or duplicated, as suitable for the application. In some embodiments, some or all of the components included in the electrical device 1400 may be attached to one or more motherboards mainboards, or system boards. In some embodiments, one or more of these components are fabricated onto a single system-on-a-chip (SoC) die.

Additionally, in various embodiments, the electrical device 1400 may not include one or more of the components illustrated in FIG. 14, but the electrical device 1400 may include interface circuitry for coupling to the one or more components. For example, the electrical device 1400 may not include a display device 1406, but may include display device interface circuitry (e.g., a connector and driver circuitry) to which a display device 1406 may be coupled. In another set of examples, the electrical device 1400 may not include an audio input device 1424 or an audio output device 1408, but may include audio input or output device interface circuitry (e.g., connectors and supporting circuitry) to which an audio input device 1424 or audio output device 1408 may be coupled.

The electrical device 1400 may include one or more processor units 1402 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1402 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 1400 may include a memory 1404, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1404 may include memory that is located on the same integrated circuit die as the processor unit 1402. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 1400 can comprise one or more processor units 1402 that are heterogeneous or asymmetric to another processor unit 1402 in the electrical device 1400. There can be a variety of differences between the processing units 1402 in a system in terms of a spectrum of metrics of merit including architectural, microarchitectural, thermal, power consumption characteristics, and the like. These differences can effectively manifest themselves as asymmetry and heterogeneity among the processor units 1402 in the electrical device 1400.

In some embodiments, the electrical device 1400 may include a communication component 1412 (e.g., one or more communication components). For example, the communication component 1412 can manage wireless communications for the transfer of data to and from the electrical device 1400. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1412 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1412 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1412 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1412 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1412 may operate in accordance with other wireless protocols in other embodiments. The electrical device 1400 may include an antenna 1422 to facilitate wireless communications and/or to receive other wireless communications (such as AM or FM radio transmissions).

In some embodiments, the communication component 1412 may manage wired communications, such as electrical, optical, or any other suitable communication protocols (e.g., IEEE 802.3 Ethernet standards). As noted above, the communication component 1412 may include multiple communication components. For instance, a first communication component 1412 may be dedicated to shorter-range wireless communications such as Wi-Fi or Bluetooth, and a second communication component 1412 may be dedicated to longer-range wireless communications such as global positioning system (GPS), EDGE, GPRS, CDMA, WiMAX, LTE, EV-DO, or others. In some embodiments, a first communication component 1412 may be dedicated to wireless communications, and a second communication component 1412 may be dedicated to wired communications.

The electrical device 1400 may include battery/power circuitry 1414. The battery/power circuitry 1414 may include one or more energy storage devices (e.g., batteries or capacitors) and/or circuitry for coupling components of the electrical device 1400 to an energy source separate from the electrical device 1400 (e.g., AC line power).

The electrical device 1400 may include a display device 1406 (or corresponding interface circuitry, as discussed above). The display device 1406 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1400 may include an audio output device 1408 (or corresponding interface circuitry, as discussed above). The audio output device 1408 may include any embedded or wired or wirelessly connected external device that generates an audible indicator, such speakers, headsets, or earbuds.

The electrical device 1400 may include an audio input device 1424 (or corresponding interface circuitry, as discussed above). The audio input device 1424 may include any embedded or wired or wirelessly connected device that generates a signal representative of a sound, such as microphones, microphone arrays, or digital instruments (e.g., instruments having a musical instrument digital interface (MIDI) output). The electrical device 1400 may include a Global Navigation Satellite System (GNSS) device 1418 (or corresponding interface circuitry, as discussed above), such as a Global Positioning System (GPS) device. The GNSS device 1418 may be in communication with a satellite-based system and may determine a geolocation of the electrical device 1400 based on information received from one or more GNSS satellites, as known in the art.

The electrical device 1400 may include an other output device 1410 (or corresponding interface circuitry, as discussed above). Examples of the other output device 1410 may include an audio codec, a video codec, a printer, a wired or wireless transmitter for providing information to other devices, or an additional storage device.

The electrical device 1400 may include an other input device 1420 (or corresponding interface circuitry, as discussed above). Examples of the other input device 1420 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1400 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1400 may be any other electronic device that processes data. In some embodiments, the electrical device 1400 may comprise multiple discrete physical components. Given the range of devices that the electrical device 1400 can be manifested as in various embodiments, in some embodiments, the electrical device 1400 can be referred to as a computing device or a computing system.

### EXAMPLES

Illustrative examples of the technologies disclosed herein are provided below. An embodiment of the technologies may include any one or more, and any combination of, the examples described below.

Example 1 includes an apparatus comprising a processor comprising a processor core, the processor core comprising instruction management circuitry, digital instruction execution circuitry and analog instruction execution circuitry, the instruction management circuitry to receive a plurality of instructions; determine whether individual instructions of the plurality of instructions are digital instructions or analog instructions; transmit individual digital instructions of the plurality of instructions to the digital instruction execution circuitry in response to a determination that the corresponding individual instructions are digital instructions; and transmit individual analog instructions of the plurality of instructions to the analog instruction execution circuitry in response to a determination that the corresponding individual instructions are analog instructions, the analog instruction execution circuitry to execute analog instructions received from the instruction management circuitry, wherein to execute analog instructions comprises to generate or measure an analog signal at an input/output of the processor.

Example 2 includes the subject matter of Example 1, and wherein the digital instruction execution circuitry is to execute instructions to load one or more parameters in one or more registers, wherein the analog instruction execution circuitry is to execute instructions to generate an analog pulse based on the one or more parameters in the one or more registers.

Example 3 includes the subject matter of any of Examples 1 and 2, and wherein the one or more parameters in the one or more registers are used to control an amplitude and a frequency of the analog pulse.

Example 4 includes the subject matter of any of Examples 1-3, and wherein the analog instruction execution circuitry is to execute an instruction to generate an analog pulse and measure a reflection of the generated analog pulse.

Example 5 includes the subject matter of any of Examples 1-4, and wherein the analog instruction execution circuitry operates in a first clock domain, wherein the digital instruction execution circuitry operates in a second clock domain different from the first clock domain.

Example 6 includes the subject matter of any of Examples 1-5, and wherein the processor comprises a plurality of processor cores, wherein individual processor cores of the plurality of processor cores comprise instruction management circuitry to receive a plurality of instructions; determine whether individual instructions of the plurality of instructions are digital instructions or analog instructions; transmit individual digital instructions of the plurality of instructions to digital instruction execution circuitry in response to a determination that the corresponding instructions are digital instructions; and transmit individual analog instructions of the plurality of instructions to analog instruction execution circuitry in response to a determination that the corresponding instructions are analog instructions; digital instruction execution circuitry to execute digital instructions received from the instruction management circuitry; and analog instruction execution circuitry to execute analog instructions received from the instruction management circuitry, wherein to execute analog instructions comprises to generate or measure an analog signal at an input/output of the processor.

Example 7 includes the subject matter of any of Examples 1-6, and wherein the processor further comprises a core synchronization matrix to synchronize between processor cores of the plurality of processor cores.

Example 8 includes the subject matter of any of Examples 1-7, and further including a plurality of processors, wherein individual processors are in separate packages, wherein individual processors of the plurality of processors comprises a plurality of processor cores, wherein individual processor cores of the plurality of processor cores of individual processors of the plurality of processors comprise instruction management circuitry to receive a plurality of instructions; determine whether individual instructions of the plurality of instructions are digital instructions or analog instructions; transmit individual digital instructions of the plurality of instructions to digital instruction execution circuitry in response to a determination that the corresponding instructions are digital instructions; and transmit individual analog instructions of the plurality of instructions to analog instruction execution circuitry in response to a determination that the corresponding instructions are analog instructions; digital instruction execution circuitry to execute digital instructions received from the instruction management circuitry; and analog instruction execution circuitry to execute analog instructions received from the instruction management circuitry, wherein to execute analog instructions comprises to generate or measure an analog signal at an input/output of the processor.

Example 9 includes the subject matter of any of Examples 1-8, and wherein individual processors of the plurality of processors comprise a core synchronization matrix to synchronize with other processors of the plurality of processors.

Example 10 includes the subject matter of any of Examples 1-9, and wherein the analog instruction execution circuitry comprises a plurality of digital signal processors, wherein the plurality of digital signal processors are to execute a plurality of analog instructions in parallel.

Example 11 includes the subject matter of any of Examples 1-10, and further including a plurality of qubits, wherein individual digital signal processors of the plurality of digital signal processors are to control two or more qubits of the plurality of qubits.

Example 12 includes the subject matter of any of Examples 1-11, and wherein the instruction management circuitry is to receive the plurality of instructions in a single clock cycle.

Example 13 includes the subject matter of any of Examples 1-12, and wherein a latency of transmission of individual analog instructions of the plurality of instructions to the analog instruction execution circuitry is less than one nanosecond.

Example 14 includes the subject matter of any of Examples 1-13, and wherein the processor has a von Neumann architecture.

Example 15 includes an apparatus comprising a plurality of qubits; and a processor, wherein the processor is to execute digital instructions and analog instructions, wherein to execute analog instructions comprises to send an analog signal to a qubit of the plurality of qubits or measure an analog signal from a qubit of the plurality of qubits.

Example 16 includes the subject matter of Example 15, and further including a plurality of processors, wherein individual processors are in separate packages, wherein individual processors of the plurality of processors are to execute digital instructions and analog instructions, wherein to execute analog instructions comprises to send an analog signal to a qubit of the plurality of qubits or measure an analog signal from a qubit of the plurality of qubits.

Example 17 includes the subject matter of any of Examples 15 and 16, and wherein the processor is to execute instructions to load one or more parameters in one or more registers, wherein the processor is to execute instructions to generate an analog pulse based on the one or more parameters in the one or more registers.

Example 18 includes the subject matter of any of Examples 15-17, and wherein the one or more parameters in the one or more registers are used to control an amplitude and a frequency of the analog pulse.

Example 19 includes the subject matter of any of Examples 15-18, and wherein the processor is to execute an instruction to generate an analog pulse and measure a reflection of the generated analog pulse.

Example 20 includes the subject matter of any of Examples 15-19, and wherein the processor comprises a plurality of processor cores, wherein individual processor cores of the plurality of processor cores are to execute digital instructions and analog instructions, wherein to execute analog instructions comprises to send an analog signal to a qubit of the plurality of qubits or measure an analog signal from a qubit of the plurality of qubits.

Example 21 includes the subject matter of any of Examples 15-20, and wherein the processor further comprises a core synchronization matrix to synchronize between processor cores of the plurality of processor cores.

Example 22 includes the subject matter of any of Examples 15-21, and further including a plurality of processors, wherein individual processors are in separate packages, wherein individual processors of the plurality of processors comprises a plurality of processor cores, wherein individual processor cores of the plurality of processor cores of individual processors of the plurality of processors are to execute digital instructions and analog instructions, wherein to execute analog instructions comprises to send an analog signal to a qubit of the plurality of qubits or measure an analog signal from a qubit of the plurality of qubits.

Example 23 includes the subject matter of any of Examples 15-22, and wherein individual processors of the plurality of processors comprise a core synchronization matrix to synchronize with other processors of the plurality of processors.

Example 24 includes the subject matter of any of Examples 15-23, and wherein the processor comprises a plurality of digital signal processors, wherein the plurality of digital signal processors are to execute a plurality of analog instructions in parallel.

Example 25 includes the subject matter of any of Examples 15-24, and wherein individual digital signal processors of the plurality of digital signal processors are to control two or more qubits of the plurality of qubits.

Example 26 includes the subject matter of any of Examples 15-25, and wherein the processor is to receive a plurality of instructions in a single clock cycle.

Example 27 includes the subject matter of any of Examples 15-26, and wherein the processor has a von Neumann architecture.

Example 28 includes a quantum compute device comprising a first processor; a plurality of qubits; a second processor; and one or more computer-readable media comprising a plurality of instructions for the first processor stored there that, when executed by the first processor, cause the first processor to send a plurality of instructions for the second processor to the second processor, wherein the plurality of instructions for the second processor comprises one or more digital instructions and one or more analog instructions, wherein the one or more analog instructions, when executed by the second processor, cause the second processor to generate or measure an analog signal at an input/output of the second processor.

Example 29 includes the subject matter of Example 28, and wherein the plurality of instructions for the first processor further cause the first processor to compile code into the plurality of instructions for the second processor, wherein to compile the code into the plurality of instructions for the second processor comprises to optimize the one or more digital instructions and the one or more analog instructions of the plurality of instructions for the second processor.

Example 30 includes the subject matter of any of Examples 28 and 29, and wherein the second processor comprises a plurality of cores, wherein to optimize the one or more digital instructions and the one or more analog instructions of the plurality of instructions for the second processor comprises to optimize the one or more digital instructions and the one or more analog instructions of the plurality of instructions for the plurality of cores.

Example 31 includes the subject matter of any of Examples 28-30, and wherein to optimize the one or more digital instructions and the one or more analog instructions of the plurality of instructions for the second processor comprises to optimize the one or more digital instructions and the one or more analog instructions of the plurality of instructions for a plurality of second processors.

Example 32 includes the subject matter of any of Examples 28-31, and wherein the one or more digital instructions, when executed by the second processor, cause the second processor to load one or more parameters in one or more registers, wherein the one or more analog instructions, when executed by the second processor, cause the second processor to generate an analog pulse based on the one or more parameters in the one or more registers.

Example 33 includes the subject matter of any of Examples 28-32, and wherein the one or more parameters in the one or more registers are used to control an amplitude and a frequency of the analog pulse.

Example 34 includes the subject matter of any of Examples 28-33, and wherein the one or more digital instructions, when executed by the second processor, cause the second processor to generate an analog pulse and measure a reflection of the generated analog pulse.

Example 35 includes the subject matter of any of Examples 28-34, and wherein the second processor comprises a plurality of processor cores.

Example 36 includes the subject matter of any of Examples 28-35, and wherein the second processor further comprises a core synchronization matrix to synchronize between processor cores of the plurality of processor cores.

Example 37 includes the subject matter of any of Examples 28-36, and wherein the quantum compute device comprises a plurality of second processors, further comprising scheduling instructions on individual second processors of the plurality of digital/analog processors.

Example 38 includes the subject matter of any of Examples 28-37, and wherein individual second processors of the plurality of second processors comprise a core synchronization matrix to synchronize with other second processors of the plurality of second processors.

Example 39 includes the subject matter of any of Examples 28-38, and wherein the plurality of instructions for the first processor further cause the first processor to communicate, by the first processor, with individual core synchronization matrices of the plurality of second processors to synchronize the plurality of second processors.

Example 40 includes the subject matter of any of Examples 28-39, and wherein the second processor comprises a plurality of digital signal processors, wherein the plurality of digital signal processors are to execute a plurality of analog instructions in parallel.

Example 41 includes the subject matter of any of Examples 28-40, and wherein individual digital signal processors of the plurality of digital signal processors are to control two or more qubits of the plurality of qubits.

Example 42 includes the subject matter of any of Examples 28-41, and wherein the second processor has a von Neumann architecture.

Example 43 includes a method comprising sending, by a first processor of a quantum compute device, a plurality of instructions for a second processor of the quantum compute device to the second processor, wherein the plurality of instructions for the second processor comprises one or more digital instructions and one or more analog instructions, wherein the one or more analog instructions, when executed by the second processor, cause the second processor to generate or measure an analog signal at an input/output of the second processor.

Example 44 includes the subject matter of Example 43, and further including compiling, by the first processor, code into the plurality of instructions for the second processor, wherein compiling the code into the plurality of instructions for the second processor comprises optimizing the one or more digital instructions and the one or more analog instructions of the plurality of instructions for the second processor.

Example 45 includes the subject matter of any of Examples 43 and 44, and wherein the second processor comprises a plurality of cores, wherein optimizing the one or more digital instructions and the one or more analog instructions of the plurality of instructions for the second processor comprises optimizing the one or more digital instructions and the one or more analog instructions of the plurality of instructions for the plurality of cores.

Example 46 includes the subject matter of any of Examples 43-45, and wherein optimizing the one or more digital instructions and the one or more analog instructions of the plurality of instructions for the second processor comprises optimizing the one or more digital instructions and the one or more analog instructions of the plurality of instructions for a plurality of second processors.

Example 47 includes the subject matter of any of Examples 43-46, and wherein the one or more digital instructions, when executed by the second processor, cause the second processor to load one or more parameters in one or more registers, wherein the one or more analog instructions, when executed by the second processor, cause the second processor to generate an analog pulse based on the one or more parameters in the one or more registers.

Example 48 includes the subject matter of any of Examples 43-47, and wherein the one or more parameters in the one or more registers are used to control an amplitude and a frequency of the analog pulse.

Example 49 includes the subject matter of any of Examples 43-48, and wherein the one or more digital instructions, when executed by the second processor, cause the second processor to generate an analog pulse and measure a reflection of the generated analog pulse.

Example 50 includes the subject matter of any of Examples 43-49, and wherein the second processor comprises a plurality of processor cores.

Example 51 includes the subject matter of any of Examples 43-50, and wherein the second processor further comprises a core synchronization matrix to synchronize between processor cores of the plurality of processor cores.

Example 52 includes the subject matter of any of Examples 43-51, and wherein the quantum compute device comprises a plurality of second processors, further comprising scheduling instructions on individual second processors of the plurality of digital/analog processors.

Example 53 includes the subject matter of any of Examples 43-52, and wherein individual second processors of the plurality of second processors comprise a core synchronization matrix to synchronize with other second processors of the plurality of second processors.

Example 54 includes the subject matter of any of Examples 43-53, and further including communicating, by the first processor, with individual core synchronization matrices of the plurality of second processors to synchronize the plurality of second processors.

Example 55 includes the subject matter of any of Examples 43-54, and wherein the second processor comprises a plurality of digital signal processors, wherein the plurality of digital signal processors are to execute a plurality of analog instructions in parallel.

Example 56 includes the subject matter of any of Examples 43-55, and wherein the quantum compute device comprise a plurality of qubits, wherein individual digital signal processors of the plurality of digital signal processors are to control two or more qubits of the plurality of qubits.

Example 57 includes the subject matter of any of Examples 43-56, and wherein the second processor has a von Neumann architecture.

Example 58 includes a quantum compute device comprising a first processor a plurality of qubits; a second processor; and means for sending a plurality of instructions for the second processor of the quantum compute device to the second processor, wherein the plurality of instructions for the second processor comprises one or more digital instructions and one or more analog instructions, wherein the one or more analog instructions, when executed by the second processor, cause the second processor to generate or measure an analog signal at an input/output of the second processor.

Example 59 includes the subject matter of Example 58, and further including means for compiling, by the first processor, code into the plurality of instructions for the second processor, wherein the means for compiling the code into the plurality of instructions for the second processor comprises means for optimizing the one or more digital instructions and the one or more analog instructions of the plurality of instructions for the second processor.

Example 60 includes the subject matter of any of Examples 58 and 59, and wherein the second processor comprises a plurality of cores, wherein the means for optimizing the one or more digital instructions and the one or more analog instructions of the plurality of instructions for the second processor comprises means for optimizing the one or more digital instructions and the one or more analog instructions of the plurality of instructions for the plurality of cores.

Example 61 includes the subject matter of any of Examples 58-60, and wherein the means for optimizing the one or more digital instructions and the one or more analog instructions of the plurality of instructions for the second processor comprises means for optimizing the one or more digital instructions and the one or more analog instructions of the plurality of instructions for a plurality of second processors.

Example 62 includes the subject matter of any of Examples 58-61, and wherein the one or more digital instructions, when executed by the second processor, cause the second processor to load one or more parameters in one or more registers, wherein the one or more analog instructions, when executed by the second processor, cause the second processor to generate an analog pulse based on the one or more parameters in the one or more registers.

Example 63 includes the subject matter of any of Examples 58-62, and wherein the one or more parameters in the one or more registers are used to control an amplitude and a frequency of the analog pulse.

Example 64 includes the subject matter of any of Examples 58-63, and wherein the one or more digital instructions, when executed by the second processor, cause the second processor to generate an analog pulse and measure a reflection of the generated analog pulse.

Example 65 includes the subject matter of any of Examples 58-64, and wherein the second processor comprises a plurality of processor cores.

Example 66 includes the subject matter of any of Examples 58-65, and wherein the second processor further comprises a core synchronization matrix to synchronize between processor cores of the plurality of processor cores.

Example 67 includes the subject matter of any of Examples 58-66, and wherein the quantum compute device comprises a plurality of second processors, further comprising means for scheduling instructions on individual second processors of the plurality of digital/analog processors.

Example 68 includes the subject matter of any of Examples 58-67, and wherein individual second processors of the plurality of second processors comprise a core synchronization matrix to synchronize with other second processors of the plurality of second processors.

Example 69 includes the subject matter of any of Examples 58-68, and further including means for communicating, by the first processor, with individual core synchronization matrices of the plurality of second processors to synchronize the plurality of second processors.

Example 70 includes the subject matter of any of Examples 58-69, and wherein the second processor comprises a plurality of digital signal processors, wherein the plurality of digital signal processors are to execute a plurality of analog instructions in parallel.

Example 71 includes the subject matter of any of Examples 58-70, and wherein individual digital signal processors of the plurality of digital signal processors are to control two or more qubits of the plurality of qubits.

Example 72 includes the subject matter of any of Examples 58-71, and wherein the second processor has a von Neumann architecture.

Example 73 includes one or more computer-readable media comprising a plurality of instructions for a first processor of a quantum compute device stored thereon that, when executed, causes the first processor to send a plurality of instructions for a second processor to the second processor, wherein the plurality of instructions for the second processor comprises one or more digital instructions and one or more analog instructions, wherein the one or more analog instructions, when executed by the second processor, cause the second processor to generate or measure an analog signal at an input/output of the second processor.

Example 74 includes the subject matter of Example 73, and wherein the plurality of instructions for the first processor further cause the first processor to compile code into the plurality of instructions for the second processor, wherein to compile the code into the plurality of instructions for the second processor comprises to optimize the one or more digital instructions and the one or more analog instructions of the plurality of instructions for the second processor.

Example 75 includes the subject matter of any of Examples 73 and 74, and wherein the second processor comprises a plurality of cores, wherein to optimize the one or more digital instructions and the one or more analog instructions of the plurality of instructions for the second processor comprises to optimize the one or more digital instructions and the one or more analog instructions of the plurality of instructions for the plurality of cores.

Example 76 includes the subject matter of any of Examples 73-75, and wherein to optimize the one or more digital instructions and the one or more analog instructions of the plurality of instructions for the second processor comprises to optimize the one or more digital instructions and the one or more analog instructions of the plurality of instructions for a plurality of second processors.

Example 77 includes the subject matter of any of Examples 73-76, and wherein the one or more digital instructions, when executed by the second processor, cause the second processor to load one or more parameters in one or more registers, wherein the one or more analog instructions, when executed by the second processor, cause the second processor to generate an analog pulse based on the one or more parameters in the one or more registers.

Example 78 includes the subject matter of any of Examples 73-77, and wherein the one or more parameters in the one or more registers are used to control an amplitude and a frequency of the analog pulse.

Example 79 includes the subject matter of any of Examples 73-78, and wherein the one or more digital instructions, when executed by the second processor, cause the second processor to generate an analog pulse and measure a reflection of the generated analog pulse.

Example 80 includes the subject matter of any of Examples 73-79, and wherein the second processor comprises a plurality of processor cores.

Example 81 includes the subject matter of any of Examples 73-80, and wherein the second processor further comprises a core synchronization matrix to synchronize between processor cores of the plurality of processor cores.

Example 82 includes the subject matter of any of Examples 73-81, and wherein the quantum compute device comprises a plurality of second processors, further comprising scheduling instructions on individual second processors of the plurality of digital/analog processors.

Example 83 includes the subject matter of any of Examples 73-82, and wherein individual second processors of the plurality of second processors comprise a core synchronization matrix to synchronize with other second processors of the plurality of second processors.

Example 84 includes the subject matter of any of Examples 73-83, and wherein the plurality of instructions for the first processor further cause the first processor to communicate, by the first processor, with individual core synchronization matrices of the plurality of second processors to synchronize the plurality of second processors.

Example 85 includes the subject matter of any of Examples 73-84, and wherein the second processor comprises a plurality of digital signal processors, wherein the plurality of digital signal processors are to execute a plurality of analog instructions in parallel.

Example 86 includes the subject matter of any of Examples 73-85, and wherein individual digital signal processors of the plurality of digital signal processors are to control two or more qubits of a plurality of qubits.

Example 87 includes the subject matter of any of Examples 73-86, and wherein the second processor has a von Neumann architecture.

Example 88 includes a quantum compute device comprising a processor, the processor to receive an instruction; determine whether the instruction is a digital instruction or an analog instruction; and execute the instruction as an analog instruction in response to a determination that the instruction is an analog instruction, wherein to execute the instruction comprises to generate an analog signal or measure an analog signal.

Example 89 includes the quantum compute device of Example 88, the processor further to receive, by the processor, a second instruction; determine, by the processor, whether the second instruction is a digital instruction or an analog instruction; and execute, by the processor, the second instruction as a digital instruction in response to a determination that the second instruction is a digital instruction.

Example 90 includes the subject matter of any of Examples 88 and 89, and wherein to execute the second instruction comprises to load one or more parameters in one or more registers, wherein to execute the instruction comprises to generate an analog pulse based on the one or more parameters in the one or more registers.

Example 91 includes the subject matter of any of Examples 88-90, and wherein the one or more parameters in the one or more registers are used to control an amplitude and a frequency of the analog pulse.

Example 92 includes the subject matter of any of Examples 88-91, and wherein to execute the instruction comprises to generate an analog pulse and measure a reflection of the generated analog pulse.

Example 93 includes the subject matter of any of Examples 88-92, and wherein the processor comprises a plurality of processor cores.

Example 94 includes the subject matter of any of Examples 88-93, and wherein the processor further comprises a core synchronization matrix to synchronize between processor cores of the plurality of processor cores.

Example 95 includes the subject matter of any of Examples 88-94, and wherein the processor comprises a plurality of digital signal processors, wherein the plurality of digital signal processors are to execute a plurality of analog instructions in parallel.

Example 96 includes the subject matter of any of Examples 88-95, and wherein individual digital signal processors of the plurality of digital signal processors are to control two or more qubits of a plurality of qubits.

Example 97 includes the subject matter of any of Examples 88-96, and wherein the processor is further to receive a plurality of instructions in a single clock cycle.

Example 98 includes the subject matter of any of Examples 88-97, and wherein the processor has a von Neumann architecture.

Example 99 includes a method comprising receiving, by a processor, an instruction; determining, by the processor, whether the instruction is a digital instruction or an analog instruction; and executing, by the processor, the instruction as an analog instruction in response to a determination that the instruction is an analog instruction, wherein executing the instruction comprises generating an analog signal or measuring an analog signal.

Example 100 includes the method of Example 99, the method further comprising receiving, by the processor, a second instruction; determining, by the processor, whether the second instruction is a digital instruction or an analog instruction; and executing, by the processor, the second instruction as a digital instruction in response to a determination that the second instruction is a digital instruction.

Example 101 includes the subject matter of any of Examples 99 and 100, and wherein executing the second instruction comprises to load one or more parameters in one or more registers, wherein executing the instruction comprises generating an analog pulse based on the one or more parameters in the one or more registers.

Example 102 includes the subject matter of any of Examples 99-101, and wherein the one or more parameters in the one or more registers are used to control an amplitude and a frequency of the analog pulse.

Example 103 includes the subject matter of any of Examples 99-102, and wherein executing the instruction comprises generating an analog pulse and measuring a reflection of the generated analog pulse.

Example 104 includes the subject matter of any of Examples 99-103, and wherein the processor comprises a plurality of processor cores.

Example 105 includes the subject matter of any of Examples 99-104, and wherein the processor further comprises a core synchronization matrix to synchronize between processor cores of the plurality of processor cores.

Example 106 includes the subject matter of any of Examples 99-105, and wherein the processor comprises a plurality of digital signal processors, wherein the plurality of digital signal processors are to execute a plurality of analog instructions in parallel.

Example 107 includes the subject matter of any of Examples 99-106, and wherein individual digital signal processors of the plurality of digital signal processors are to control two or more qubits of a plurality of qubits.

Example 108 includes the subject matter of any of Examples 99-107, and further including receiving, by the processor, a plurality of instructions in a single clock cycle.

Example 109 includes the subject matter of any of Examples 99-108, and wherein the processor has a von Neumann architecture.

Example 110 includes a quantum compute device comprising means for receiving an instruction; means for determining whether the instruction is a digital instruction or an analog instruction; and means for executing the instruction as an analog instruction in response to a determination that the instruction is an analog instruction, wherein the means for executing the instruction comprises means for generating an analog signal or measuring an analog signal.

Example 111 includes the subject matter of Example 110, and further including means for receiving a second instruction; means for determining whether the second instruction is a digital instruction or an analog instruction; and means for executing the second instruction as a digital instruction in response to a determination that the second instruction is a digital instruction.

Example 112 includes the subject matter of any of Examples 110 and 111, and wherein the means for executing the second instruction comprises to load one or more parameters in one or more registers, wherein the means for executing the instruction comprises means for generating an analog pulse based on the one or more parameters in the one or more registers.

Example 113 includes the subject matter of any of Examples 110-112, and wherein the one or more parameters in the one or more registers are used to control an amplitude and a frequency of the analog pulse.

Example 114 includes the subject matter of any of Examples 110-113, and wherein the means for executing the instruction comprises means for generating an analog pulse and measuring a reflection of the generated analog pulse.

Example 115 includes the subject matter of any of Examples 110-114, and wherein the means for executing the instruction as an analog instruction comprises a plurality of digital signal processors, wherein the plurality of digital signal processors are to execute a plurality of analog instructions in parallel.

Example 116 includes the subject matter of any of Examples 110-115, and wherein individual digital signal processors of the plurality of digital signal processors are to control two or more qubits of a plurality of qubits.

Example 117 includes the subject matter of any of Examples 110-116, and further including means for receiving a plurality of instructions in a single clock cycle.

Example 118 includes the subject matter of any of Examples 110-117, and wherein the means for executing the instruction as an analog instruction has a von Neumann architecture.

1. An apparatus comprising:
a processor comprising a processor core, the processor core comprising:
instruction management circuitry, digital instruction execution circuitry and analog instruction execution circuitry, the instruction management circuitry to:
receive a plurality of instructions;
determine whether individual instructions of the plurality of instructions are digital instructions or analog instructions;
transmit individual digital instructions of the plurality of instructions to the digital instruction execution circuitry in response to a determination that the corresponding individual instructions are digital instructions; and
transmit individual analog instructions of the plurality of instructions to the analog instruction execution circuitry in response to a determination that the corresponding individual instructions are analog instructions,
the analog instruction execution circuitry to execute analog instructions received from the instruction management circuitry, wherein to execute analog instructions comprises to generate or measure an analog signal at an input/output of the processor.

2. The apparatus of claim 1, wherein the digital instruction execution circuitry is to execute instructions to load one or more parameters in one or more registers, wherein the analog instruction execution circuitry is to execute instructions to generate an analog pulse based on the one or more parameters in the one or more registers.

3. The apparatus of claim 2, wherein the one or more parameters in the one or more registers are used to control an amplitude and a frequency of the analog pulse.

4. The apparatus of claim 1, wherein the analog instruction execution circuitry is to execute an instruction to generate an analog pulse and measure a reflection of the generated analog pulse.

5. The apparatus of claim 1, wherein the analog instruction execution circuitry operates in a first clock domain, wherein the digital instruction execution circuitry operates in a second clock domain different from the first clock domain.

6. The apparatus of claim 1, wherein the analog instruction execution circuitry comprises a plurality of digital signal processors, wherein the plurality of digital signal processors are to execute a plurality of analog instructions in parallel.

7. The apparatus of claim 6, further comprising a plurality of qubits, wherein individual digital signal processors of the plurality of digital signal processors are to control two or more qubits of the plurality of qubits.

8. The apparatus of claim 1, wherein the instruction management circuitry is to receive the plurality of instructions in a single clock cycle.

9. The apparatus of claim 1, wherein a latency of transmission of individual analog instructions of the plurality of instructions to the analog instruction execution circuitry is less than one nanosecond.

10. An apparatus comprising:
a plurality of qubits; and
a processor,
wherein the processor is to execute digital instructions and analog instructions, wherein to execute analog instructions comprises to send an analog signal to a qubit of the plurality of qubits or measure an analog signal from a qubit of the plurality of qubits.

11. The apparatus of claim 10, further comprising a plurality of processors, wherein individual processors are in separate packages,
wherein individual processors of the plurality of processors are to execute digital instructions and analog instructions, wherein to execute analog instructions comprises to send an analog signal to a qubit of the plurality of qubits or measure an analog signal from a qubit of the plurality of qubits.

12. The apparatus of claim 10, wherein the processor is to execute instructions to load one or more parameters in one or more registers, wherein the processor is to execute instructions to generate an analog pulse based on the one or more parameters in the one or more registers.

13. The apparatus of claim 12, wherein the one or more parameters in the one or more registers are used to control an amplitude and a frequency of the analog pulse.

14. The apparatus of claim 10, wherein the processor is to execute an instruction to generate an analog pulse and measure a reflection of the generated analog pulse.

15. The apparatus of claim 10, wherein the processor comprises a plurality of processor cores, wherein individual processor cores of the plurality of processor cores are to execute digital instructions and analog instructions, wherein to execute analog instructions comprises to send an analog signal to a qubit of the plurality of qubits or measure an analog signal from a qubit of the plurality of qubits.

16. The apparatus of claim 15, wherein the processor further comprises a core synchronization matrix to synchronize between processor cores of the plurality of processor cores.

17. The apparatus of claim 10, further comprising a plurality of processors, wherein individual processors are in separate packages, wherein individual processors of the plurality of processors comprises a plurality of processor cores, wherein individual processor cores of the plurality of processor cores of individual processors of the plurality of processors are to execute digital instructions and analog instructions, wherein to execute analog instructions comprises to send an analog signal to a qubit of the plurality of qubits or measure an analog signal from a qubit of the plurality of qubits.

18. The apparatus of claim 17, wherein individual processors of the plurality of processors comprise a core synchronization matrix to synchronize with other processors of the plurality of processors.

19. The apparatus of claim 10, wherein the processor comprises a plurality of digital signal processors, wherein the plurality of digital signal processors are to execute a plurality of analog instructions in parallel.

20. The apparatus of claim 19, wherein individual digital signal processors of the plurality of digital signal processors are to control two or more qubits of the plurality of qubits.

21. The apparatus of claim 10, wherein the processor is to receive a plurality of instructions in a single clock cycle.

22. A quantum compute device comprising:
a first processor;
a plurality of qubits;
a second processor; and
one or more computer-readable media comprising a plurality of instructions for the first processor stored there that, when executed by the first processor, cause the first processor to:
send a plurality of instructions for the second processor to the second processor, wherein the plurality of instructions for the second processor comprises one or more digital instructions and one or more analog instructions, wherein the one or more analog instructions, when executed by the second processor, cause the second processor to generate or measure an analog signal at an input/output of the second processor.

23. The quantum compute device of claim 22, wherein the plurality of instructions for the first processor further cause the first processor to:
compile code into the plurality of instructions for the second processor, wherein to compile the code into the plurality of instructions for the second processor comprises to optimize the one or more digital instructions and the one or more analog instructions of the plurality of instructions for the second processor.

24. The quantum compute device of claim 23, wherein the second processor comprises a plurality of cores, wherein to optimize the one or more digital instructions and the one or more analog instructions of the plurality of instructions for the second processor comprises to optimize the one or more digital instructions and the one or more analog instructions of the plurality of instructions for the plurality of cores.

25. The quantum compute device of claim 23, wherein to optimize the one or more digital instructions and the one or more analog instructions of the plurality of instructions for the second processor comprises to optimize the one or more digital instructions and the one or more analog instructions of the plurality of instructions for a plurality of second processors.
